(19) United States
(12) Patent Application Publication
(10) Pub. No.: US 2026/0225308 A1
(43) Pub. Date: Aug. 6, 2026

(54) METHODS OF PRODUCING AND DETERMINING CLEANABILITY OF PARTS FOR BIOPROCESSING SYSTEMS

(71) Applicant: CYTIVA SWEDEN AB, Uppsala (SE)

(72) Inventors: Klas Marteleur, Uppsala (SE); Alvaro Morales Lopez, Stockholm (SE); Anna Finne Wistrand, Stockholm (SE)

(21) Appl. No.: 19/152,096

(22) PCT Filed: Jan. 15, 2024
(86) PCT No.: PCT/EP2024/050808

§ 371 Date: Jul. 30, 2025

(30) Foreign Application Priority Data
Jan. 31, 2023 (SE) 2301376.6

(51) Int. Cl. B29C 59/16; B29C 64/153; B33Y 10/00; B33Y 40/20

(52) U.S. Cl. CPC B29C 59/16; B33Y 40/20; B29C 64/153; B33Y 10/00

(57) ABSTRACT

The present disclosure relates to a method (100) of producing a part for use in a bioprocessing system, the method comprising: manufacturing (110) the part using an additive manufacturing process; and postprocessing (120) a surface of the part, wherein the surface is intended to be wetted in use; wherein the postprocessed surface has one or more of the following areal roughness parameter values measured (220) in accordance with ISO 25178-2:2022, wherein the one or more areal roughness parameter values are measured for the surface after filtering the surface to remove surface features having wavelengths below 2.5 μm and surface features having wavelengths above 11 μm: a mean dale area, Sda, of between 50 μm² and 600 μm²; a mean hill area, Sha, of between 50 μm² and 500 μm²; a density of peaks, Spd, of between 3000 mm⁻² and 10000 mm⁻²; 15 and a kurtosis, Sku, of between 6 and 20.

### FIELD

The present disclosure relates to a method of producing a part for use in a bioprocessing system, and a method of determining cleanability of a surface of a part for use in a bioprocessing system.

### BACKGROUND

3D printing technology (also referred to as additive manufacturing (AM)) has been in existence since the 1980s when it was primarily used for rapid prototyping for product development within certain industries. The technological growth and possibility of mass production of the different technologies within AM have proven their potential to complement and even replace conventional manufacturing techniques. Some of the advantages that AM offers to the bioprocessing industry are the possibility of increasing geometry complexity and reducing costs and material waste while requiring low manufacturing skills.

Among the existing AM technologies, powder bed fusion (PBF) is the most developed and mature platform able to provide models with different shapes and sizes by using powder-based materials. However, various technical and regulatory challenges prevent the implementation of PBF technologies in the bioprocessing field. In particular, technical aspects related to cleanability, sterility, surface finish and dimensions should be designed according to good engineering principles to minimize bacterial adhesion on the surface of the components.

Despite the continued improvement in the regulation, standards, and quality control for the production of bioprocessing equipment, bacterial adhesion leading to biofilm formation is a serious threat to human health and is responsible for 80% of the microbial infections occurring in the human body. Apart from its health impact, biofilm formation has enormous economic consequences in different fields. For instance, in the biopharmaceutical field, bacterial adhesion, which leads to biofilm formation in the interior of bioprocessing equipment, results in an economic loss of billions in revenue. At present, there is a lack of understanding of how 3D-printed surfaces interact with bacteria and how to prevent bacterial growth and reduce biofilm formation to meet the high microbiological requirements on components for use in contact with biological systems.

Among the surface properties of the material, surface roughness is considered the most critical parameter influencing biofilm formation. Some studies have shown that rougher surfaces increase bacterial adhesion, and thereby, irreversible biofilm formation increases proportionally with roughness. However, other studies have reported that smoother surfaces do not significantly influence bacterial adhesion.

In addition to surface roughness, the second most important aspect that affects bacterial adhesion is the surface wettability property, which is generally reported in terms of the apparent contact angle. The contact angle value modulates the interactions between solid and liquid phases. It has been demonstrated that surfaces with an extremely high or low wettability could reduce biofilm formation, while a regular pattern has not been found for surfaces with moderate wettability.

There is thus a need for an improved method of validating the suitability of a 3D-printed part for use in a bioprocessing system. In particular, there is a need for a method that provides a more thorough validation of whether a 3D-printed part is likely to result in biofilm formation, and the cleanability of the 3D-printed part. In addition, there is a need for an improved method of manufacturing 3D-printed parts to ensure their suitability for use in a bioprocessing system.

Hence the present invention, as defined by the appended claims, is provided.

### SUMMARY

This summary introduces concepts that are described in more detail in the detailed description. It should not be used to identify essential features of the claimed subject matter, nor to limit the scope of the claimed subject matter.

According to a first aspect of the present disclosure, there is provided a method of producing a part for use in a bioprocessing system, the method comprising: manufacturing the part using an additive manufacturing process; and postprocessing a surface of the part, wherein the surface is intended to be wetted in use; wherein the postprocessed surface has one or more of the following areal roughness parameter values measured in accordance with ISO 25178-2:2022, wherein the one or more areal roughness parameter values are measured for the surface after filtering the surface to remove surface features having wavelengths below 2.5 μm and surface features having wavelengths above 11 μm: a mean dale area, Sda, of between 50 μm² and 600 μm²; a mean hill area, Sha, of between 50 μm² and 500 μm²; a density of peaks, Spd, of between 3000 mm⁻² and 10000 mm⁻²; and a kurtosis, Sku, of between 6 and 20.

The method of the first aspect allows for the manufacture of additively manufactured parts with cleanable surfaces. In particular, by tailoring the postprocessing to include one or more of the areal roughness parameter values listed in the method of the first aspect, an additively manufactured part can be validated as cleanable without the need for inefficient and time-consuming validation methods. Current processes for validating the cleanability of additively manufactured parts involve destructive testing of a certain number of prototypes, leading to additional waste and reduced manufacturing efficiency. In particular, alternative methods for validating the cleanability of additively manufactured parts would involve contaminating a certain number of prototypes in order to promote biofilm growth, before attempting to clean the prototypes and determining the effectiveness of such cleaning. Such methods are time-consuming, owing to the need for biofilm growth. Such methods also involve manual work and involve the potential for additional contaminants to be introduced as a consequence of the manual handling of the selected prototypes being tested. Such methods require the manufacture of additional parts that are to be tested, and may require many parts to be tested in order to provide statistical validity. Each surface would also need to be measured using a profilometer or microscope in order for a determination to be made that the part is cleanable.

In contrast, the method of the first aspect allows for verification that an additively manufactured part produced using the method is cleanable, by tailoring the postprocessing of the surfaces of the additively manufactured part in order to provide one or more areal surface roughness values that correspond to surface roughness values of cleanable surfaces currently used in the bioprocessing industry.

According to a second aspect of the present disclosure, there is provided an additively manufactured part for use in a bioprocessing system, wherein the additively manufactured part comprises a surface intended to be wetted in use, wherein the surface has one or more of the following areal roughness parameter values measured in accordance with ISO 25178-2:2022, wherein the one or more areal roughness parameter values are measured for the surface after filtering the surface to remove surface features having wavelengths below 2.5 μm and surface features having wavelengths above 11 μm: a mean dale area, Sda, of between 50 and 600 μm²; a mean hill area, Sha, of between 50 and 500 μm²; a density of peaks, Spd, of between 3000 mm⁻² and 10000 mm⁻²; and a kurtosis, Sku, of between 6 and 20.

According to a third aspect of the present disclosure, there is provided a method of determining cleanability of a surface of a part for use in a bioprocessing system, the method comprising: manufacturing the part, wherein the part comprises a surface that is intended to be wetted in use; and one or more of: measuring a mean dale area, Sda, of the surface after filtering the surface to remove surface features having wavelengths below 2.5 μm and surface features having wavelengths above 11 μm, and determining that the surface is cleanable if the mean dale area, Sda, of the surface is between 50 μm² and 600 μm²; measuring a mean hill area, Sha, of the surface after filtering the surface to remove surface features having wavelengths below 2.5 μm and surface features having wavelengths above 11 μm, and determining that the surface is cleanable if the mean dale area, Sda, of the surface is between 50 μm² and 500 μm²; measuring a density of peaks, Spd, of the surface after filtering the surface to remove surface features having wavelengths below 2.5 μm and surface features having wavelengths above 11 μm, and determining that the surface is cleanable if the density of peaks, Spd, of the surface is between 3000 mm⁻² and 10000 mm⁻²; and measuring a kurtosis, Sku, of the surface after filtering the surface to remove surface features having wavelengths below 2.5 μm and surface features having wavelengths above 11 μm, and determining that the surface is cleanable if the kurtosis, Sku, of the surface is between 6 and 20.

The method of the third aspect allows for the determination of whether surfaces of parts (and in particular, surfaces of additively manufactured parts) are cleanable in an efficient manner. Current processes for determining the cleanability of additively manufactured parts involve destructive testing of a certain number of prototypes, leading to additional waste and reduced manufacturing efficiency, as explained above.

In contrast, the method of the second aspects allows for a determination of whether surfaces of parts (in particular, additively manufactured parts) are cleanable based on measurement of one or more areal surface roughness values that have the strongest association with cleanable surfaces currently used in the bioprocessing industry. This allows for validation of surfaces of parts as cleanable in a more efficient manner.

### BRIEF DESCRIPTION OF FIGURES

Specific embodiments are described below by way of example only and with reference to the accompanying drawings, in which:

FIG. 1 shows a flowchart of a method of producing of a part for use in a bioprocessing system.

FIG. 2 shows a flowchart of a method of determining cleanability of a surface of a part for use in a bioprocessing system.

FIG. 3 shows weights of artificial test soil (ATS) deposited on top of sample surfaces comprising a surface produced by CNC milling and surfaces produced by SLS that have been subjected to different degrees of postprocessing, according to a first example.

FIG. 4 shows percentages of ATS that are removed from sample surfaces after cleaning and drying, according to the first example.

FIG. 5 shows relative light unit (RLU) values for contaminated sample surfaces, according to the first example.

FIG. 6 shows the RLU values in FIG. 5 along with RLU values for positive and negative controls of each sample surface.

FIG. 7 shows a plot of relative area of sample surfaces according to the first example.

FIG. 8 shows a plot of complexity of sample surfaces according to the first example.

FIG. 9 shows the degree of divergence of roughness parameters between a surface produced by CNC milling and a postprocessed surface produced by SLS, according to the first example.

FIG. 10 shows values of maximum dale aspect ratio, Sdarx, of sample surfaces according to the first example.

FIG. 11 shows values of density of peaks per area, Spd, of sample surfaces according to the first example.

FIG. 12 shows values of arithmetical mean height, Sa, of sample surfaces according to the first example.

FIG. 13 shows a correlation between the percentages of ATS shown in FIG. 4 and the Sdarx values shown in FIG. 10.

FIG. 14 shows a correlation between the percentages of ATS shown in FIG. 4 and the Spd values shown in FIG. 11.

FIG. 15 shows a correlation between the percentages of ATS shown in FIG. 4 and values of autocorrelation length, Sal, of sample surfaces according to the first example.

FIG. 16 shows a correlation between the percentages of ATS shown in FIG. 4 and values of kurtosis, Sku, of sample surfaces according to the first example.

FIG. 17 shows a correlation between the percentages of ATS shown in FIG. 4 and values of density of pits, Svd, of sample surfaces according to the first example.

FIG. 18 shows a correlation between the percentages of ATS shown in FIG. 4 and values of mean dale area, Sda, of sample surfaces according to the first example.

FIG. 19 shows a correlation between the percentages of ATS shown in FIG. 4 and values of maximum dale area, Sdax, of sample surfaces according to the first example.

FIG. 20 shows a correlation between the percentages of ATS shown in FIG. 4 and values of standard deviation of dale area, Sdaq, of sample surfaces according to the first example.

FIG. 21 shows a correlation between the percentages of ATS shown in FIG. 4 and values of mean hill area, Sha, of sample surfaces according to the first example.

FIG. 22 shows a correlation between the percentages of ATS shown in FIG. 4 and values of maximum hill area, Shax, of sample surfaces according to the first example.

FIG. 23 shows a correlation between the percentages of ATS shown in FIG. 4 and values of standard deviation of hill area, Shaq, of sample surfaces according to the first example.

FIG. 24 shows a correlation between the percentages of ATS shown in FIG. 4 and values of dale count, Sdn, of sample surfaces according to the first example.

FIG. 25 shows a correlation between the percentages of ATS shown in FIG. 4 and values of hill count, Shn, of sample surfaces according to the first example.

FIG. 26 shows a correlation between the percentages of ATS shown in FIG. 4 and values of mean dale equivalent diameter, Sded, of sample surfaces according to the first example.

FIG. 27 shows a correlation between the percentages of ATS shown in FIG. 4 and values of maximum dale equivalent diameter, Sdedx, of sample surfaces according to the first example.

FIG. 28 shows a correlation between the percentages of ATS shown in FIG. 4 and values of standard deviation of dale equivalent diameter, Sdedq, of sample surfaces according to the first example.

FIG. 29 shows a correlation between the percentages of ATS shown in FIG. 4 and values of mean hill equivalent diameter, Shed, of sample surfaces according to the first example.

FIG. 30 shows a correlation between the percentages of ATS shown in FIG. 4 and values of maximum hill equivalent diameter, Shedx, of sample surfaces according to the first example.

FIG. 31 shows a correlation between the percentages of ATS shown in FIG. 4 and values of standard deviation of hill equivalent diameter, Shedq, of sample surfaces according to the first example.

FIG. 32 shows a correlation between the percentages of ATS shown in FIG. 4 and values of mean dale form factor, Sdff, of sample surfaces according to the first example.

FIG. 33 shows a correlation between the percentages of ATS shown in FIG. 4 and values of maximum dale form factor, Sdffx, of sample surfaces according to the first example.

FIG. 34 shows a correlation between the percentages of ATS shown in FIG. 4 and values of mean hill form factor, Shff, of sample surfaces according to the first example.

FIG. 35 shows a correlation between the percentages of ATS shown in FIG. 4 and values of maximum hill form factor, Shffx, of sample surfaces according to the first example.

FIG. 36 shows a correlation between the percentages of ATS shown in FIG. 4 and values of maximum dale roundness, Sdrnx, of sample surfaces according to the first example.

FIG. 37 shows a correlation between the percentages of ATS shown in FIG. 4 and values of maximum hill roundness, Shrnx, of sample surfaces according to the first example.

FIG. 38 shows a plot of advancing and receding contact angles of sample surfaces according to the first example.

### DETAILED DESCRIPTION

Implementations of the present disclosure are explained below with particular reference to manufacturing and determining cleanability of parts used in bioprocessing systems. It will be appreciated, however, that the methods described herein may also be used to manufacture and determine the cleanability of parts used in other settings. Moreover, implementations of the present disclosure are explained below with particular reference to determining cleanability of additively manufactured parts. It will further be appreciated, however, that the methods described herein may also be used to determine the cleanability of parts manufactured using other manufacturing techniques.

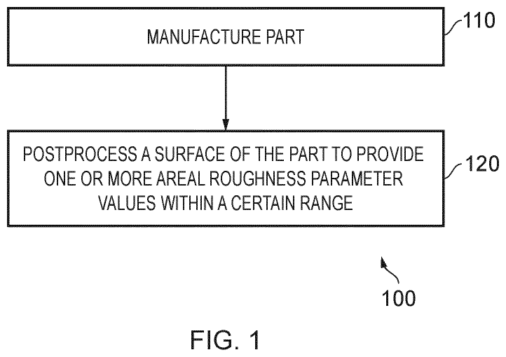

FIG. 1 is a flowchart of a method 100 of producing a part.

At 110, the part is manufactured using an additive manufacturing process. As one example, the part may be manufactured using an additive manufacturing process such as powder bed fusion (PBF), laser powder bed fusion (LPBF) or electron beam melting (EBM). In particular, a PBF process may include selective layer sintering (SLS). In one example, the manufactured part is intended for use in a bioprocessing system and comprises a surface that is intended to be wetted when the part is used in the bioprocessing system.

At 120, the surface of the part is postprocessed to provide one or more areal roughness parameter values within a certain range. In one example, postprocessing the surface includes laser polishing of the surface.

In one example, the one or more areal roughness parameters can be measured by analysing images of the surface obtained using a confocal laser scanning microscope (CLSM), such as a VK-X1000 confocal laser scanning microscope available from Keyence Corporation of Osaka, Japan. The areal roughness parameters relate to a scale-limited surface, so measurement of the one or more areal roughness parameters firstly involves filtering one or more CLSM images of the surface of the part according to an appropriate scale range. In the examples described herein, surface feature wavelengths below 2.5 μm are filtered out of the CLSM images, and surface feature wavelengths above 11 μm are filtered out of the CLSM images. In alternative examples, a different filtering range (such as 2 μm to 25 μm) may be used. It will be appreciated, however, that the choice of filtering range affects the values of the areal roughness parameters. Accordingly, implementing a different filtering range may alter the values of the areal roughness parameters set out below.

The postprocessing of the part at 120 may include postprocessing the surface to provide one or more surface wettability values (e.g. advancing contact angle values and/or receding contact angle values) within a certain range. Dynamic contact angles including advancing and receiving contact angles can be measured using an optical tensiometer, such as a Theta Lite optical tensiometer available from Biolin Scientific of Gothenburg, Sweden. In one example, the needle method can be used to measure the dynamic contact angles, in which advancing contact angles are measured for 100 seconds of advancing time with an advancing rate of 0.4 μL s⁻¹, and receding contact angles are measured for 100 seconds of receding time with a receding rate of 0.4 μL s⁻¹. Before analysis, samples are sanitised with 70% isopropyl alcohol (IPA) and dried with compressed nitrogen to remove contaminants and dust particles. To measure the dynamic contact angles, the advancing contact angle is first measured by dispensing a 5 μL outsize drop on the sample surface. Then, a needle is brought close to the surface, and the droplet volume is gradually increased at a fill rate of 0.4 μL s⁻¹. Next, the receding contact angle is measured by decreasing the volume of the droplet at a dispensing rate of 0.4 μL s⁻¹. Calculation of the advancing and receding contact angles can be measured using software such as OneAttension software available from Biolin Scientific of Gothenburg, Sweden.

The values of the areal roughness parameters provided by the postprocessing of the surface at 120 relate to areal roughness parameters that have been identified as providing a correlation with cleanability of a surface. As described in more detail in the example below, these areal roughness parameters have been determined by comparing a postprocessed surface of a part manufactured using SLS with a surface of a part manufactured using computer numerical control (CNC) milling. Surfaces of parts manufactured using CNC milling are representative of surfaces used in the bioprocessing industry today and that are proven not to cause bacterial adhesion and biofilm formation. The determination of the relevant one or more roughness parameters does not form part of the method 100. Instead, it will be appreciated based on the discussion below that a comparison of the SLS surfaces with reference CNC milling surfaces yields the roughness parameters of greatest relevance. The postprocessing of the surface at 120 is carried out in order to provide one or more areal roughness parameter values for the roughness parameters of greatest relevance.

As described further in the example below, a surface of a part manufactured using CNC milling may be compared with a surface of a part that has been manufactured using SLS. In particular, relevant areal roughness parameters are identified based on a comparison of a reference CNC milling surface with a SLS surface that has been postprocessed. In the example described below, the postprocessed SLS surface selected for comparison with the CNC milling surface was a postprocessed SLS surface with a high degree of cleanability (i.e. a postprocessed surface with the same degree of cleanability as the CNC milling surface). The example below therefore involves a determination of the cleanability of various postprocessed SLS surfaces and the reference CNC milling surface, in order to determine the postprocessed SLS surface with the highest degree of cleanability. As noted above, surfaces produced by CNC milling are currently used in bioprocessing equipment because they have a high degree of cleanability. In the example, therefore, the surfaces selected for comparison both have a high degree of cleanability, and the two surfaces were compared in order to determine areal roughness parameters with the lowest degree of divergence between the surfaces.

Standardised areal roughness parameters are defined in ISO 25178. In particular, roughness parameters that are used to describe surface topography are defined in ISO 25178-2:2022. Most existing studies on the influence of surface roughness on biofilm formation focus only on the arithmetical mean deviations, Ra and Sa, which describe respectively the average height from a 2-dimensional profile and a 3-dimensional surface. In contrast, the present disclosure involves consideration of a number of different areal roughness parameters, which have been found to be of greater relevance to surface cleanability than the arithmetical mean deviations, Ra and Sa.

Specifically, the surface of the part may be postprocessed at 120 to provide one or more areal roughness parameter values relating to one or more of the following 25 areal roughness parameters measured in accordance with ISO 25178-2:2022: kurtosis, Sku; density of peaks, Spd (mm⁻²); density of pits, Svd (mm⁻²); mean dale area, Sda (μm²); maximum dale area, Sdax (μm²); standard deviation of dale area, Sdaq (μm²); mean hill area, Sha (μm²); maximum hill area, Shax (μm²); standard deviation of hill area, Shaq (μm²); dale count, Sdn; hill count, Shn; mean dale equivalent diameter, Sded (μm); maximum dale equivalent diameter, Sdedx (μm); standard deviation of dale equivalent diameter, Sdedq (μm); mean hill equivalent diameter, Shed (μm); maximum hill equivalent diameter, Shedx (μm); standard deviation of hill equivalent diameter, Shedq (μm); mean dale form factor, Sdff; maximum dale form factor, Sdffx; mean hill form factor, Shff; maximum hill form factor, Shffx; maximum dale roundness, Sdrnx; maximum hill roundness, Shrnx; maximum dale aspect ratio, Sdarx; and autocorrelation length, Sal (μm). These areal roughness parameters are identified in the example below as being the parameters having high similarity based on a comparison of surfaces found to have high degrees of cleanability, and having strong correlation with surface cleanability.

ISO 25178-2:2022 includes a number of parameters falling within a category of “feature” parameters. Many of the parameters listed above fall within this category. According to this category, there are three types of features: areal (hills and dales), line (course and ridge lines), and point features (peaks, pits and saddle points). Areal roughness parameters relating to areal surface features include parameters relating to the height, area, volume, and count (quantity) of the areal surface features (hills and dales). The relevant areal roughness parameters listed above include all areal roughness parameters in ISO 25178-2:2022 relating to the area of areal surface features.

In order to identify hills and dales on the surface, a watershed algorithm is typically applied in order to partition the surface into regions. Smaller segments are then pruned out using the Wolf pruning method, which removes regions below a certain height/depth threshold (e.g. 5% of the maximum height of the surface, Sz). Segmentation of the surface is defined in ISO 25178-2:2022 and can be carried out using surface analysis software such as MountainsLab® software available from Digital Surf of Besançon, France.

Additional areal roughness parameters relating to areal surface features include parameters relating to the roundness, form factor, equivalent diameter, and aspect ratio of the areal surface features. Roundness is a ratio of the motif (hill or dale) horizontal area to the area of a circle with a diameter equal to the maximum diameter. A round object will yield a value of 1, whereas an oblong object will yield a value of less than 1. Form factor is a measure of the compacity of the shape (i.e. the filled volume fraction). An elongated object will yield a value close to zero, while a compact object will yield a value close to 1. Equivalent diameter is the diameter of a circle of the same area as the motif (hill or dale). Aspect ratio is a ratio of the maximum diameter to the minimum diameter, and discriminates between compact and oblong motifs (where a disc has a value of 1 and an oblong motif has a value greater than 1).

As explained above, the values of the areal roughness parameters listed above are dependent on the scale over which the surface is limited. The surface of the part may be postprocessed at 120 to provide one or more areal roughness parameter values within the ranges set out in the following paragraphs. The areal roughness parameter values listed below result from filtering the surface features to remove surface feature wavelengths below 2.5 μm and to remove surface feature wavelengths above 11 μm.

The postprocessing of the surface at 120 may provide one or more of:
(i) a kurtosis, Sku, value of the 2.5 μm to 11 μm scale-limited surface of between 6 and 20, preferably between 7 and 18, more preferably between 8 and 16, or most preferably between 9 and 14. Kurtosis (Sku) is a measure of surface sharpness, with higher Sku values indicating sharper peaks and pits (as opposed to more rounded features);
(ii) a density of peaks, Spd, of the 2.5 μm to 11 μm scale-limited surface of between 3000 mm⁻² and 10000 mm⁻², preferably between 3500 mm⁻² and 9000 mm⁻², more preferably between 4000 mm⁻² and 8000 mm⁻², more preferably between 4500 mm⁻² and 7500 mm-2, more preferably between 5000 mm⁻² and 7000 mm⁻², or most preferably between 5500 mm⁻² and 6500 mm⁻²;
(iii) a density of pits, Svd, of the 2.5 μm to 11 μm scale-limited surface of between 3000 mm⁻² and 10000 mm⁻², preferably between 3500 mm⁻² and 8000 mm⁻², more preferably between 4000 mm⁻² and 7000 mm⁻², more preferably between 4500 mm 2 and 6000 mm-2, or most preferably between 4000 mm⁻² and 5000 mm⁻²;
(iv) a mean dale area, Sda, of the 2.5 μm to 11 μm scale-limited surface of between 50 μm² and 600 μm², preferably between 75 μm² and 500 μm², more preferably between 100 μm² and 400 μm², more preferably between 125 μm² and 300 μm², or most preferably between 150 μm² and 250 μm²;
(v) a maximum dale area, Sdax, of the 2.5 μm to 11 μm scale-limited surface of less than 7000 μm², preferably less than 6000 μm², more preferably less than 5000 μm², more preferably less than 4000 μm², or most preferably less than 3000 μm²;
(vi) a standard deviation of dale area, Sdaq, of the 2.5 μm to 11 μm scale-limited surface of less than 600 μm², preferably less than 500 μm², more preferably less than 400 μm², more preferably less than 300 μm², and most preferably less than 250 μm²;
(vii) a mean hill area, Sha, of the 2.5 μm to 11 μm scale-limited surface of between 50 μm² and 500 μm², preferably between 75 μm² and 400 μm², more preferably between 100 μm² and 300 μm², more preferably between 125 μm² and 250 μm², or most preferably between 150 μm² and 200 μm²;
(viii) a maximum hill area, Shax, of the 2.5 μm to 11 μm scale-limited surface of less than 6000 μm², preferably less than 5000 μm², more preferably less than 4000 μm², more preferably less than 3000 μm², or most preferably less than 2000 μm²;
(ix) a standard deviation of hill area, Shaq, of the 2.5 μm to 11 μm scale-limited surface of less than 500 μm², preferably less than 400 μm², more preferably less than 300 μm², more preferably less than 250 μm², and most preferably less than 200 μm²;
(x) a dale count, Sdn, of the 2.5 μm to 11 μm scale-limited surface of between 1000 and 2000, preferably between 1100 and 1900, more preferably between 1200 and 1800, more preferably between 1300 and 1700, and most preferably between 1400 and 1650;
(xi) a hill count Shn, of the 2.5 μm to 11 μm scale-limited surface of between 1000 and 3000, preferably between 1200 and 2800, more preferably between 1400 and 2600, more preferably between 1600 and 2400, and most preferably between 1800 and 2200;
(xii) a mean dale equivalent diameter, Sded, of the 2.5 μm to 11 μm scale-limited surface of between 6 μm and 24 μm, preferably between 8 μm and 22 μm, more preferably between 10 μm and 20 μm, more preferably between 12 μm and 18 μm, and most preferably between 14 μm and 16 μm;
(xiii) a maximum dale equivalent diameter, Sdedx, of the 2.5 μm to 11 μm scale-limited surface of less than 90 μm, preferably less than 80 μm, more preferably less than 70 μm, more preferably less than 65 μm, and most preferably less than 60 μm;
(xiv) a standard deviation of dale equivalent diameter, Sdedq, of the 2.5 μm to 11 μm scale-limited surface of less than 14 μm, preferably less than 11 μm, more preferably less than 9 μm, more preferably less than 8 μm, and most preferably less than 7 μm;
(xv) a mean hill equivalent diameter, Shed, of the 2.5 μm to 11 μm scale-limited surface of between 5 μm and 23 μm, preferably between 7 μm and 21 μm, more preferably between 9 μm and 19 μm, more preferably between 11 μm and 17 μm, and most preferably between 13 μm and 15 μm;
(xvi) a maximum hill equivalent diameter, Shedx, of the 2.5 μm to 11 μm scale-limited surface of less than 70 μm, preferably less than 65 μm, more preferably less than 60 μm, more preferably less than 55 μm, and most preferably less than 50 μm;
(xvii) a standard deviation of hill equivalent diameter, Shedq, of the 2.5 μm to 11 μm scale-limited surface of less than 14 μm, preferably less than 11 μm, more preferably less than 9 μm, more preferably less than 8 μm, and most preferably less than 7 μm;
(xviii) a mean dale form factor, Sdff, of the 2.5 μm to 11 μm scale-limited surface of between 0.44 and 0.54, preferably between 0.45 and 0.53, more preferably between 0.46 and 0.52, more preferably between 0.47 and 0.51, or most preferably between 0.48 and 0.50;
(xix) a maximum dale form factor, Sdffx, of the 2.5 μm to 11 μm scale-limited surface of between 0.815 and 0.875, preferably between 0.825 and 0.865, or more preferably between 0.835 and 0.855;
(xx) a mean hill form factor, Shff, of the 2.5 μm to 11 μm scale-limited surface of between 0.45 and 0.55, preferably between 0.46 and 0.54, more preferably between 0.47 and 0.53, more preferably between 0.48 and 0.52, or most preferably between 0.49 and 0.51;
(xxi) a maximum hill form factor, Shffx, of the 2.5 μm to 11 μm scale-limited surface of between 0.80 and 0.94, preferably between 0.82 and 0.92, more preferably between 0.84 and 0.90, or most preferably between 0.86 and 0.88;
(xxii) a maximum dale roundness, Sdrnx, of the 2.5 μm to 11 μm scale-limited surface of between 0.815 and 0.875, preferably between 0.825 and 0.865, or more preferably between 0.835 and 0.855;
(xxiii) a maximum hill roundness, Shrnx, of the 2.5 μm to 11 μm scale-limited surface of between 0.83 and 0.90, preferably between 0.84 and 0.89, more preferably between 0.85 and 0.88, or most preferably between 0.86 and 0.87;
(xxiv) a maximum dale aspect ratio, Sdarx, of the 2.5 μm to 11 μm scale-limited surface of between 11 and 18, preferably between 12 and 17, more preferably between 13 and 16, and most preferably between 14 and 15; and
(xxv) an autocorrelation length, Sal, of the 2.5 μm to 11 μm scale-limited surface of less than 4.5 μm, preferably less than 4.25 μm, more preferably less than 4 μm, or most preferably less than 3.75 μm.

The postprocessed surface may have more than one of the areal roughness parameter values listed at (i) to (xxv). In one example, the postprocessed surface may have all of the areal roughness parameter values listed at (i) to (xxv).

In one specific example, the postprocessed surface may have one or more of the areal roughness parameter values listed at (i), (ii), (iv) and (vii) (and may, for example, have all of the areal roughness parameter values listed at (i), (ii), (iv) and (vii)). In this example, the postprocessed surface may also have one or more of the areal roughness parameter values listed at (iii), (v), (viii), (xviii), (xx) and (xxv).

In light of the strong correlation of these parameters with surface cleanability, a surface of a manufactured part is likely to be cleanable if the values of one or more of the above roughness parameters are similar to corresponding values for surfaces produced by CNC milling and/or cleanable postprocessed surfaces of parts produced by additive manufacture. Therefore, postprocessing the surface to include one or more of these values is likely to result in the surface being cleanable.

As explained above, the postprocessing of the part at 120 may include postprocessing the surface to provide one or more surface wettability values (e.g. advancing contact angle values and/or receding contact angle values) within a certain range. Specifically, the postprocessing of the surface at 120 may provide one or more of:
(xxvi) an advancing contact angle of the postprocessed surface between 80 degrees and 110 degrees, preferably between 82.5 degrees and 107.5 degrees, more preferably between 85 degrees and 105 degrees, or most preferably between 87.5 degrees and 102.5 degrees; and
(xxvii) a receding contact angle of the postprocessed surface between 55 degrees and 95 degrees, preferably between 57.5 degrees and 92.5 degrees, more preferably between 60 degrees and 90 degrees, more preferably between 62.5 degrees and 87.5 degrees, or most preferably between 65 degrees and 85 degrees.

Once a part has been manufactured using the method 100, then, depending on the postprocessing carried out at 120, the surface of the part will have one or more of the areal roughness parameter values listed at (i) to (xxv), and optionally one or more of the surface wettability values listed at (xxvi) and (xxvii).

The part manufactured using the method 100 is an additively manufactured part. The additively manufactured part may be formed of a material such as polymer. Moreover, the additively manufactured part may be formed using layers of powder material that have been bonded together using heat using a process such as PBF (e.g. SLS). This means that the additively manufactured part may include a first region (or a first plurality of regions) in which the material has not been melted, and a second region (or a second plurality of regions) in which the material has been melted and has resolidified.

The method 100 allows for the manufacture of additively manufactured parts with cleanable surfaces. In particular, by tailoring the postprocessing applied at 120 to include one or more of the areal roughness parameter values listed above, an additively manufactured part can be validated as cleanable without the need for inefficient and time-consuming validation methods. Current processes for validating the cleanability of additively manufactured parts involve destructive testing of a certain number of prototypes, leading to additional waste and reduced manufacturing efficiency. In particular, alternative methods for validating the cleanability of additively manufactured parts would involve contaminating a certain number of prototypes in order to promote biofilm growth, before attempting to clean the prototypes and determining the effectiveness of such cleaning. Such methods are time-consuming, owing to the need for biofilm growth. Such methods also involve manual work and involve the potential for additional contaminants to be introduced as a consequence of the manual handling of the selected prototypes being tested. Such methods require the manufacture of additional parts that are to be tested, and may require many parts to be tested in order to provide statistical validity. Each surface would also need to be measured using a profilometer or microscope in order for a determination to be made that the part is cleanable.

In contrast, the method 100 allows for verification that an additively manufactured part produced using the method 100 is cleanable, by tailoring the postprocessing of the surfaces of the additively manufactured part in order to provide one or more areal surface roughness values that correspond to surface roughness values of cleanable surfaces manufactured using CNC milling.

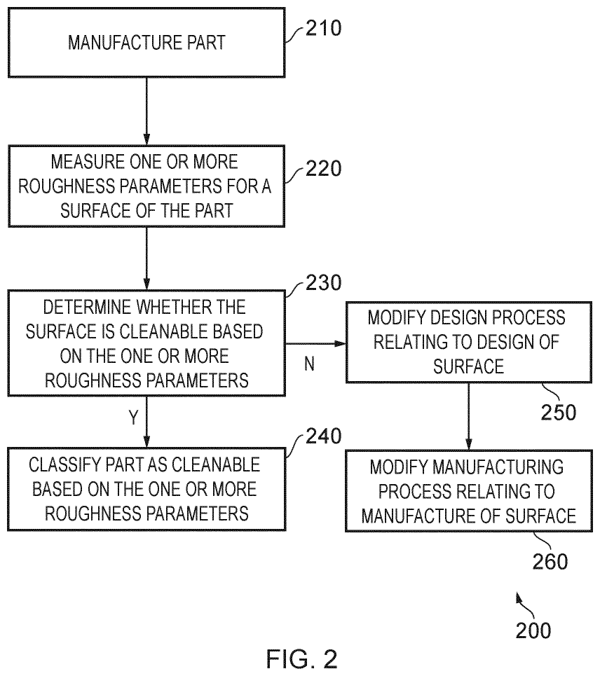

FIG. 2 is a flowchart of a method 200 of determining cleanability of a surface of a part.

At 210, a part is manufactured. The part comprises a surface that is intended to be wetted in use. The part may be manufactured using an additive manufacturing process such as powder bed fusion (PBF). Manufacturing the part at 210 may also comprise postprocessing the part.

At 220, one or more areal roughness parameters of the surface are measured (e.g. from CLSM images as described with reference to method 100). The method may include filtering the CLSM images using an appropriate scale range (such as 2.5 μm to 11 μm).

At 230, a determination is made as to whether the surface is cleanable, based on the one or more areal roughness parameters measured at 220.

If, at 230, it is determined that the surface is cleanable, then the method 200 may comprise classifying, at 240, the part as cleanable.

If, at 230, it is determined that the surface is not cleanable, then the method 200 may comprise modifying, at 250, a design process relating to the design of the surface. Alternatively or additionally, if it is determined at 230 that the surface is not cleanable, then the method may comprise modifying, at 260, a manufacturing process relating to the manufacture of the surface. Modifying the manufacturing process may include incorporating one or more postprocessing operations (such as laser polishing) into the manufacturing process, and/or modifying one or more postprocessing operations carried out at 210.

The one or more areal roughness parameters measured at 220 may include one or more of: kurtosis, Sku; density of peaks, Spd (mm⁻²); density of pits, Svd (mm⁻²); mean dale area, Sda (μm²); maximum dale area, Sdax (μm²); standard deviation of dale area, Sdaq (μm²); mean hill area, Sha (μm²); maximum hill area, Shax (μm²); standard deviation of hill area, Shaq (μm²); dale count, Sdn; hill count, Shn; mean dale equivalent diameter, Sded (μm); maximum dale equivalent diameter, Sdedx (μm); standard deviation of dale equivalent diameter, Sdedq (μm); mean hill equivalent diameter, Shed (μm); maximum hill equivalent diameter, Shedx (μm); standard deviation of hill equivalent diameter, Shedq (μm); mean dale form factor, Sdff; maximum dale form factor, Sdffx; mean hill form factor, Shff; maximum hill form factor, Shffx; maximum dale roundness, Sdrnx; maximum hill roundness, Shrnx; maximum dale aspect ratio, Sdarx; and autocorrelation length, Sal (μm).

With the exception of kurtosis (Sku) and autocorrelation length (Sal), each of the above parameters falls within the family of “feature” parameters defined in ISO 25178-2:2022. This family defines three different types of features: areal features (hills and dales), line features (course and ridge lines), and point features (peaks and pits). Accordingly, the one or more roughness parameters measured at 220 may include one or more areal roughness parameters relating to surface features (as defined in ISO 25178-2:2022).

Many of the above parameters falling within the “feature” parameters family in ISO 25178-2:2022 relate to areal features (i.e. hills and dales). Accordingly, the one or more roughness parameters measured at 220 may include one or more areal roughness parameters relating to areal surface features.

The areal roughness parameters listed above include all feature parameters in ISO 25178-2:2022 relating to the area of hills on the surface (i.e. Sha, Shax, Shaq) and all feature parameters in ISO 25178-2:2022 relating to the area of dales on the surface (i.e. Sda, Sdax, Sdaq). Accordingly, the one or more roughness parameters measured at 220 may include one or more areal roughness parameters relating to areas of areal surface features (i.e. relating to areas of surface hills and/or areas of surface dales, as defined in ISO 25178-2:2022).

The areal roughness parameters listed above include all feature parameters in ISO 25178-2:2022 relating to the equivalent diameter of hills on the surface (i.e. Shed, Shedx, Shedq) and all feature parameters in ISO 25178-2:2022 relating to the equivalent diameter of dales on the surface (i.e. Sded, Sdedx, Sdedq). Accordingly, the one or more roughness parameters measured at 220 may include one or more areal roughness parameters relating to an equivalent diameter of areal surface features (i.e. relating to an equivalent diameter of surface hills and/or an equivalent diameter of surface dales, as defined in ISO 25178-2:2022).

It may be determined at 230 that the surface is cleanable if, after filtering the surface features to remove surface feature wavelengths below 2.5 μm and to remove surface feature wavelengths above 11 μm, one or more of the following conditions are satisfied:
(i) a kurtosis, Sku, value of the 2.5 μm to 11 μm scale-limited surface is between 6 and 20, preferably between 7 and 18, more preferably between 8 and 16, or most preferably between 9 and 14. Kurtosis (Sku) is a measure of surface sharpness, with higher Sku values indicating sharper peaks and pits (as opposed to more rounded features);
(ii) a density of peaks, Spd, of the 2.5 μm to 11 μm scale-limited surface is between 3000 mm⁻² and 10000 mm⁻², preferably between 3500 mm⁻² and 9000 mm⁻², more preferably between 4000 mm⁻² and 8000 mm⁻², more preferably between 4500 mm⁻² and 7500 mm⁻², more preferably between 5000 mm⁻² and 7000 mm⁻², or most preferably between 5500 mm⁻² and 6500 mm⁻²;
(iii) a density of pits, Svd, of the 2.5 μm to 11 μm scale-limited surface is between 3000 mm⁻² and 10000 mm⁻², preferably between 3500 mm⁻² and 8000 mm⁻², more preferably between 4000 mm⁻² and 7000 mm⁻², more preferably between 4500 mm⁻² and 6000 mm⁻², or most preferably between 4000 mm⁻² and 5000 mm⁻²;
(iv) a mean dale area, Sda, of the 2.5 μm to 11 μm scale-limited surface is between 50 μm² and 600 μm², preferably between 75 μm² and 500 μm², more preferably between 100 μm² and 400 μm², more preferably between 125 μm² and 300 μm², or most preferably between 150 μm² and 250 μm²;
(v) a maximum dale area, Sdax, of the 2.5 μm to 11 μm scale-limited surface is less than 7000 μm², preferably less than 6000 μm², more preferably less than 5000 μm², more preferably less than 4000 μm², or most preferably less than 3000 μm²;
(vi) a standard deviation of dale area, Sdaq, of the 2.5 μm to 11 μm scale-limited surface is less than 600 μm², preferably less than 500 μm², more preferably less than 400 μm², more preferably less than 300 μm², and most preferably less than 250 μm²;
(vii) a mean hill area, Sha, of the 2.5 μm to 11 μm scale-limited surface is between 50 μm² and 500 μm², preferably between 75 μm² and 400 μm², more preferably between 100 μm² and 300 μm², more preferably between 125 μm² and 250 μm², or most preferably between 150 μm² and 200 μm²;
(viii) a maximum hill area, Shax, of the 2.5 μm to 11 μm scale-limited surface is less than 6000 μm², preferably less than 5000 μm², more preferably less than 4000 μm², more preferably less than 3000 μm², or most preferably less than 2000 μm²;
(ix) a standard deviation of hill area, Shaq, of the 2.5 μm to 11 μm scale-limited surface is less than 500 μm², preferably less than 400 μm², more preferably less than 300 μm², more preferably less than 250 μm², and most preferably less than 200 μm²;
(x) a dale count, Sdn, of the 2.5 μm to 11 μm scale-limited surface is between 1000 and 2000, preferably between 1100 and 1900, more preferably between 1200 and 1800, more preferably between 1300 and 1700, and most preferably between 1400 and 1650;
(xi) a hill count Shn, of the 2.5 μm to 11 μm scale-limited surface is between 1000 and 3000, preferably between 1200 and 2800, more preferably between 1400 and 2600, more preferably between 1600 and 2400, and most preferably between 1800 and 2200;
(xii) a mean dale equivalent diameter, Sded, of the 2.5 μm to 11 μm scale-limited surface is between 6 μm and 24 μm, preferably between 8 μm and 22 μm, more preferably between 10 μm and 20 μm, more preferably between 12 μm and 18 μm, and most preferably between 14 μm and 16 μm;
(xiii) a maximum dale equivalent diameter, Sdedx, of the 2.5 μm to 11 μm scale-limited surface is less than 90 μm, preferably less than 80 μm, more preferably less than 70 μm, more preferably less than 65 μm, and most preferably less than 60 μm;
(xiv) a standard deviation of dale equivalent diameter, Sdedq, of the 2.5 μm to 11 μm scale-limited surface is less than 14 μm, preferably less than 11 μm, more preferably less than 9 μm, more preferably less than 8 μm, and most preferably less than 7 μm;
(xv) a mean hill equivalent diameter, Shed, of the 2.5 μm to 11 μm scale-limited surface is between 5 μm and 23 μm, preferably between 7 μm and 21 μm, more preferably between 9 μm and 19 μm, more preferably between 11 μm and 17 μm, and most preferably between 13 μm and 15 μm;
(xvi) a maximum hill equivalent diameter, Shedx, of the 2.5 μm to 11 μm scale-limited surface is less than 70 μm, preferably less than 65 μm, more preferably less than 60 μm, more preferably less than 55 μm, and most preferably less than 50 μm;
(xvii) a standard deviation of hill equivalent diameter, Shedq, of the 2.5 μm to 11 μm scale-limited surface is less than 14 μm, preferably less than 11 μm, more preferably less than 9 μm, more preferably less than 8 μm, and most preferably less than 7 μm;
(xviii) a mean dale form factor, Sdff, of the 2.5 μm to 11 μm scale-limited surface is between 0.44 and 0.54, preferably between 0.45 and 0.53, more preferably between 0.46 and 0.52, more preferably between 0.47 and 0.51, or most preferably between 0.48 and 0.50;
(xix) a maximum dale form factor, Sdffx, of the 2.5 μm to 11 μm scale-limited surface is between 0.815 and 0.875, preferably between 0.825 and 0.865, or more preferably between 0.835 and 0.855;
(xx) a mean hill form factor, Shff, of the 2.5 μm to 11 μm scale-limited surface is between 0.45 and 0.55, preferably between 0.46 and 0.54, more preferably between 0.47 and 0.53, more preferably between 0.48 and 0.52, or most preferably between 0.49 and 0.51;
(xxi) a maximum hill form factor, Shffx, of the 2.5 μm to 11 μm scale-limited surface is between 0.80 and 0.94, preferably between 0.82 and 0.92, more preferably between 0.84 and 0.90, or most preferably between 0.86 and 0.88;
(xxii) a maximum dale roundness, Sdrnx, of the 2.5 μm to 11 μm scale-limited surface is between 0.815 and 0.875, preferably between 0.825 and 0.865, or more preferably between 0.835 and 0.855;
(xxiii) a maximum hill roundness, Shrnx, of the 2.5 μm to 11 μm scale-limited surface is between 0.83 and 0.90, preferably between 0.84 and 0.89, more preferably between 0.85 and 0.88, or most preferably between 0.86 and 0.87;
(xxiv) a maximum dale aspect ratio, Sdarx, of the 2.5 μm to 11 μm scale-limited surface is between 11 and 18, preferably between 12 and 17, more preferably between 13 and 16, and most preferably between 14 and 15; and
(xxv) an autocorrelation length, Sal, of the 2.5 μm to 11 μm scale-limited surface is less than 4.5 μm, preferably less than 4.25 μm, more preferably less than 4 μm, or most preferably less than 3.75 μm.

It may be determined at 230 that the surface is cleanable if, after filtering the surface features to remove surface feature wavelengths below 2.5 μm and to remove surface feature wavelengths above 11 μm, more than one of the conditions listed at (i) to (xxv) is satisfied. In one example, the surface may be determined as being cleanable at 230 if all of the conditions listed at (i) to (xxv) are satisfied.

In one specific example, it may be determined at 230 that the surface is cleanable if, after filtering the surface features to remove surface feature wavelengths below 2.5 μm and to remove surface feature wavelengths above 11 μm, one or more of the conditions listed at (i), (ii), (iv) and (vii) (for example, all of the conditions listed at (i), (ii), (iv) and (vii)) are satisfied. In this example, it may be determined at 230 that the surface is cleanable if, after filtering the surface features to remove surface feature wavelengths below 2.5 μm and to remove surface feature wavelengths above 11 μm, one or more of the conditions listed at (iii), (v), (viii), (xviii), (xx) and (xxv) are satisfied.

The method 200 allows for the determination of whether surfaces of parts (and in particular, surfaces of additively manufactured parts) are cleanable in an efficient manner. Current processes for determining the cleanability of additively manufactured parts involve destructive testing of a certain number of prototypes, leading to additional waste and reduced manufacturing efficiency. In particular, alternative methods for determining the cleanability of additively manufactured parts would involve contaminating a certain number of prototypes in order to promote biofilm growth, before attempting to clean the prototypes and determining the effectiveness of such cleaning. Such methods are time-consuming, owing to the need for biofilm growth. Such methods also involve manual work and involve the potential for additional contaminants to be introduced as a consequence of the manual handling of the selected prototypes being tested. Such methods require the manufacture of additional parts that are to be tested, and may require many parts to be tested in order to provide statistical validity. Each surface would also need to be measured using a profilometer or microscope in order for a determination to be made that the part is cleanable.

In contrast, the method 200 allows for a determination of whether additively manufactured parts are cleanable based on measurement of one or more areal surface roughness values that have the strongest association with cleanable surfaces manufactured using CNC milling. This allows for validation of additively manufactured parts as cleanable in a more efficient manner.

### Example

This example describes a comparison of a surface of a part manufactured using SLS with a surface of a part manufactured using CNC milling, where both surfaces have high cleanability (and are therefore similarly cleanable). This example involves determining areal roughness parameters with the greatest similarity based on the comparison of these highly cleanable surfaces, in order to establish areal roughness parameters that correlate strongly with cleanability.

In this example, two grades of polypropylene (PP), medical-grade isotactic PP homopolymer and industrial-grade isotactic PP were used as received. Medical-grade isotactic PP homopolymer available from Nordbergs Tekniska AB of Vallentuna, Sweden was used for conventional milling manufacturing, while industrial-grade isotactic PP available from Ricoh Company Ltd., of Tokyo, Japan was used in SLS.

CNC reference samples (identified herein as PP_CNC) were manufactured using a VF-8 milling machine available from Haas Automation, Inc. of Oxnard, CA, USA. Disc samples with a diameter of 25 mm and height of 5 mm were selected as reference samples.

SLS disc samples (identified herein using PP_SLS or PP_PBF) with a diameter of 25 mm and a height of 5 mm were produced by SLS. The layer thickness used in the SLS process was 0.1 mm, with a printing tolerance of +0.3%. The sample orientation during the printing process was horizontal (0°).

Different surface textures of the PP_SLS samples were obtained using six different types of postprocessing: (i) no postprocessing (i.e. as-printed SLS samples), identified herein as PP_SLS_0h or PP_PBF_0h; (ii) SLS samples tumbled for 5 h using medium abrasive media, identified herein as PP_SLS_5h or PP_PBF_5h; (iii) SLS samples tumbled for 10 h using medium abrasive media, identified herein as PP_SLS_10 h or PP_PBF_10h; (iv) SLS samples tumbled for 15 h using medium abrasive media, identified herein as PP_SLS_15 h or PP_PBF_15h; (v) SLS samples tumbled for 13 h using medium abrasive media and polished for 3 h using small abrasive media, identified herein as PP_SLS_13 h_3P or PP_PBF_13 h_3P; and (vi) SLS samples laser-polished (LP) by the technique developed by the Fraunhofer Institute, identified herein as PP_SLS_LP or PP_PBF_LP. Postprocessing approach (vi) involves irradiating the surface of the SLS sample with laser radiation in order to melt the material close to the surface, which closes cracks and pores on the surface and reduces the roughness of the surface. The surface is then allowed to resolidify in the smoothed state.

For the tumble surface finishing, ceramic triangle abrasive media (CTAM) with coarse grist, large grit size, finish matte, and a medium media attrition rate was used, along with a detergent. The detergent was used at a constant concentration and dose for each sample and did not provide any chemical energy to the surface finish process. Instead, it was used to optimize the mechanical, abrasive energy provided by the media. In the tumbling process, a combination of circular flow in the submersion tank and the detergent application caused the samples to tumble in the flow of detergent and remain under the surface of the detergent in the submersion tank.

Dynamic contact angles including advancing and receiving contact angles were measured using a Theta Lite optical tensiometer available from Biolin Scientific of Gothenburg, Sweden. The advancing contact angles were measured for 100 seconds of advancing time with an advancing rate of 0.4 μL s⁻¹, and the receding contact angles were measured for 100 seconds of receding time with a receding rate of 0.4 μL s⁻¹.

Before analysis, samples are sanitised with 70% isopropyl alcohol (IPA) and dried with compressed nitrogen to remove contaminants and dust particles. The needle method was used to measure the dynamic contact angles. First, the advancing contact angle was measured by dispensing a 5 μL outsize drop on the sample surface. Then, a needle was brought close to the surface, and the droplet volume was gradually increased at a fill rate of 0.4 μL s⁻¹. Next, the receding contact angle was measured by decreasing the volume of the droplet at a dispensing rate of 0.4 μL s⁻¹. Calculation of the advancing and receding contact angles was measured using OneAttension software available from Biolin Scientific of Gothenburg, Sweden. A total of three measurements were taken per sample at room temperature.

The surface roughness was determined by a VK-X1000 confocal laser scanning microscope (CLSM) available from Keyence Corporation of Osaka, Japan. Each surface image had a 700×525 μm² surface, which was split into four identical areas to calculate each roughness parameter in each of the mentioned areas. The following statistical data were reported: mean, standard deviation, maximum and minimum. The analysis was performed using Multi-File Analyser software. Three images per sample were taken at 20× magnification. The following roughness parameters were calculated following ISO 25178-2:2022: Sq, Ssk, Sku, Sp, Sv, Sz, Sa, Smr, Smc, Sdc, Sal, Str, Std, Ssw, Sdq, Sdr, Vm, Vv, Vmp, Vmc, Vvc, Vvv, Spd, Spc, S10z, S5p, S5v, Sda, Sha, Sdv, Shv, Svd, Svc, Shh, Shhx, Shhq, Shax, Shaq, Shvx, Shvq, Sdd, Sddx, Sddq, Sdax, Sdaq, Sdvx, Sdvq, Shn, Sdn, Shrn, Shrnx, Shrnq, Shff, Shffx, Shffq, Shed, Shedx, Shedq, Shar, Sharx, Sharq, Sdrn, Sdrnx, Sdrnq, Sdff, Sdffx, Sdffq, Sded, Sdedx, Sdedq, Sdar, Sdarx, and Sdarq.

The top surface of the samples was visualized using a TM-1000 tabletop scanning electron microscope (SEM) available from Hitachi, Ltd. of Tokyo, Japan, with an acceleration voltage of 15 kV. No conductive coating was used for the tabletop SEM evaluation. Images were acquired at magnifications of 40×, 120×, 150× and 180×.

Cleanability was initially determined by means of a contamination study involving artificial test soil (ATS). ATS is a standardised test soil with protein, haemoglobin, carbohydrates, cellulose, lipids and mucin, for simulated use testing. It is usually used for soiling of medical devices such as flexible endoscopes, for the purpose of conducting cleaning validations. ATS provides a conditioning film on the surface, which models the conditioning film that is normally created in biopharmaceutical applications by proteins and carbohydrates.

The contamination study involved gravimetric analysis in order to determine the percentage of ATS that was removed from each sample by cleaning. The gravimetric analysis included (i) a negative device control, which was a sample collected from a defined surface area on a test sample that was not soiled with ATS (identified as ‘A’ and measured in mg); (ii) a positive device control, which was a sample collected from a defined surface area on a test sample that had been soiled with ATS and allowed to dry for 3 h at 37° C. in an incubator (identified as ‘B’ and measured in mg); and (iii) a test device, which was a sample collected from a defined surface area on a test sample that had been soiled with ATS, allowed to dry for 3 h at 37° C. in an incubator and then cleaned by a defined method (identified as ‘C’ and measured in mg). Triplicated specimens were analysed. The cleanability can be defined both using the residual level of analyte, post-cleaning (mg)=C−A, or the percentage removal of analyte=((B−A)−(C−A))×100/(B−A).

The contamination study also involved measurement of relative light units (RLU) based on the detection of adenosine 5-triphosphate (ATP) bioluminescence. This method is based on the detection of ATP using the firefly luciferase enzyme and luciferin cofactor.

The experimental work steps comprised three main stages: (i) sanitisation; (ii) ATS preparation; and (iii) ATS application. In the sanitisation stage, samples were cleaned with deionised water, immersed in 70% isopropyl alcohol (IPA) and dried with nitrogen. After that, one specimen of each sample batch was deleted to measure the degree of cleanliness (negative device control) and ensure the efficiency of the sanitisation step. In the ATS preparation stage, ATS was added to sterile water in a concentration of 0.09 g/ml. The mixture was vortexed for 10 minutes before being allowed to settle for 20 minutes before application.

In the ATS application stage, each sample (kept in a sterilised petri-dish) was initially weighed. ATS was then applied to each sample, by using 1 ml of contaminant to cover the whole sample surface. Samples were then dried for 3 h at 37° C. in a shaker-incubator, which provides consistent temperature and humidity during the drying process. The weight of the samples (in the sterilised petri-dishes) was then re-measured. The samples were then cleaned in autoclaved beakers at 121° C. for 30 minutes. The beakers contained 30 ml of 70% IPA and a shaking speed of 100 rpm for 20 minutes. The samples were then placed on sterilised petri-dishes and dried at 37° C. for 2 h, before being re-weighed. ATP measurement was carried out by swabbing each surface for 30 seconds and measuring RLU immediately after.

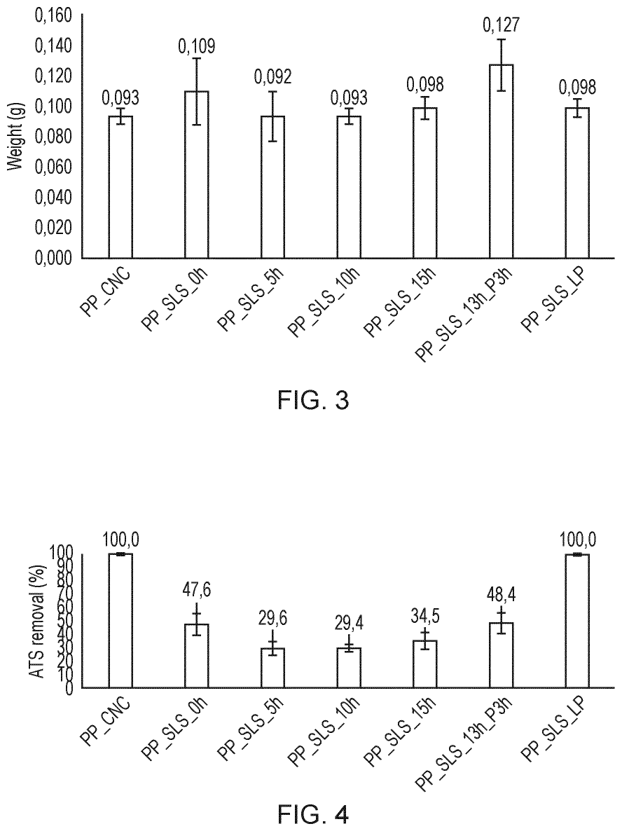

FIG. 3 shows the weight of ATS deposited on the top surface of the samples. In particular, an average of 0.102±0.011 g of ATS was deposited on each surface after drying for 3 h, thereby confirming a consistent reproducibility of the method of depositing ATS on the sample surface.

FIG. 4 shows the percentage of ATS that is removed after cleaning and drying in the incubator. For the PP_CNC and PP_SLS_LP samples, the whole ATS layer is delaminated from the surface (i.e. 100% of the ATS is removed).

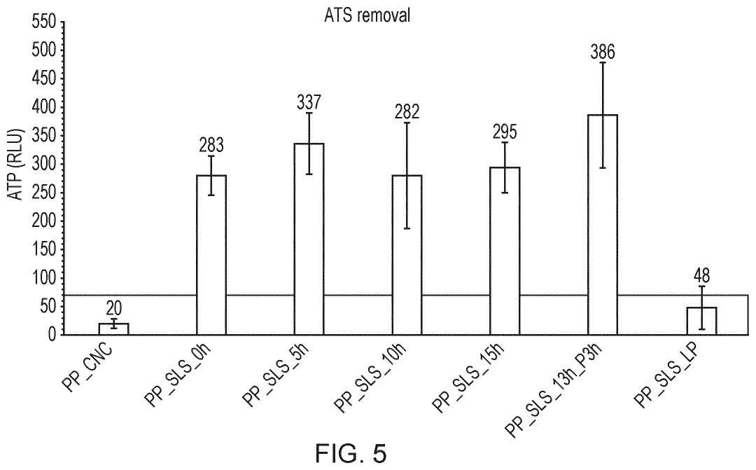

FIG. 5 shows the ATP results obtained for the experiments performed after cleaning and drying. As shown, the lowest contamination is obtained for the PP_CNC and PP_SLS_LP samples. PP_CNC samples yielded an average of 20 RLU while PP_SLS_LP samples yielded an average of 48 RLU. Both are within the range considered as “safe” for processing. Conversely, high values of RLU are found for all the tumbled SLS samples, independently of the post-processing time applied. In parallel, higher standard deviation of RLU is also found for the tumbled SLS samples due to the inconsistent surface texture of the samples.

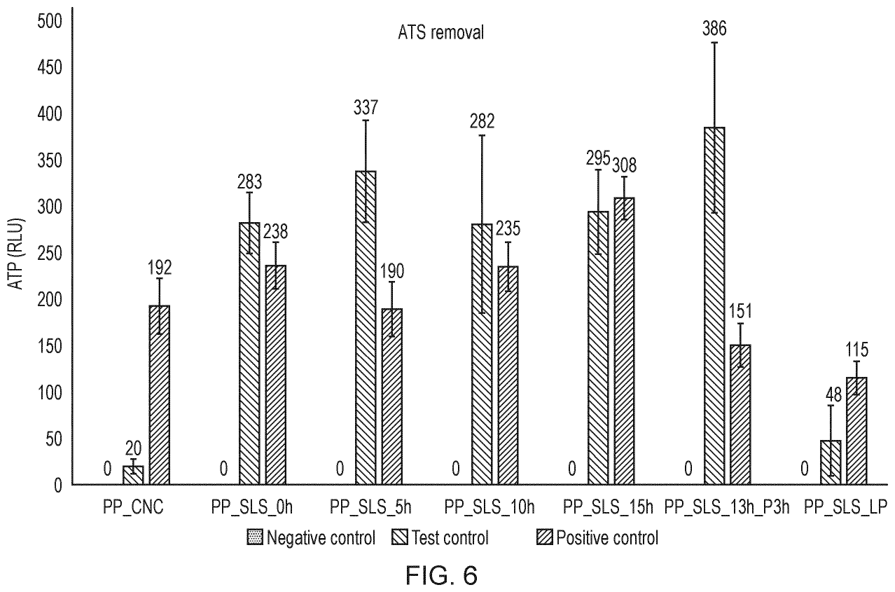

FIG. 6 shows the RLU values of the negative and positive controls to validate the reproducibility of the experimental procedure. As shown in FIG. 6, the values for the test samples manufactured by CNC and SLS followed by LP are within the values of the negative and positive controls, while the values for the rest of the AM samples are close to or above their respective positive control values.

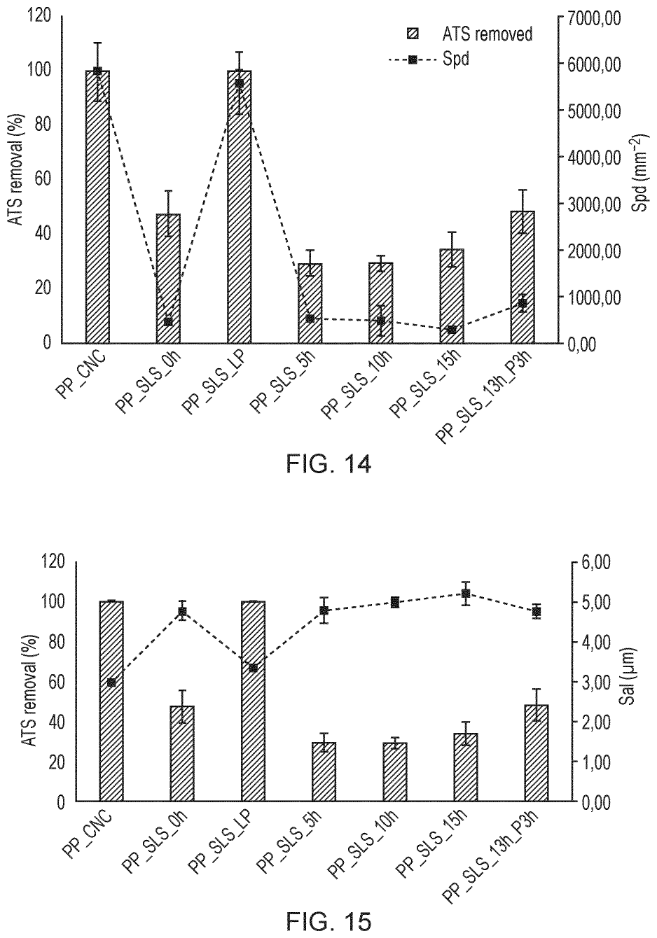

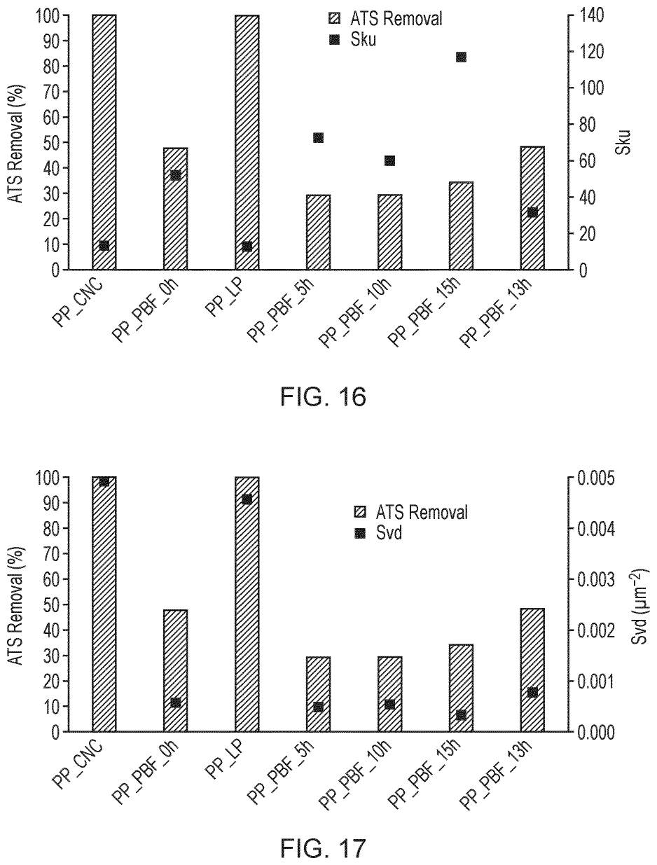

It can be concluded that LP and CNC are two examples of manufacturing processes that reduce the degree of contamination, when measured by both gravimetry (FIGS. 13 and 14) and ATP bioluminescence (FIGS. 15 and 16). On the other hand, surfaces produced by SLS and mechanically tumbled do not show any sign of cleanliness improvement.

In this example, the filters applied to the CLSM images are determined by identifying the most significant scale for characterisation of the surfaces, which was identified by scale-sensitive fractal analysis. Scale-sensitive fractal analysis is a multi-scale approach which includes area-scale analysis to calculate the area of the surface as a function of scale. Using this approach, the relative area and complexity of the surface is calculated by using a virtual tiling algorithm in which the surface topography is covered with triangular tiles. Each tile has the same area and represents the scale of measurement. The relative area at a particular scale is estimated by taking the ratio of calculated area to the nominal area at that scale. The calculated area is the product of a number of triangular tiles used to cover the surface and the scale or area of a single tile. Complexity is the measure of the slope of the relative area plot at each scale multiplied by orders of magnitude.

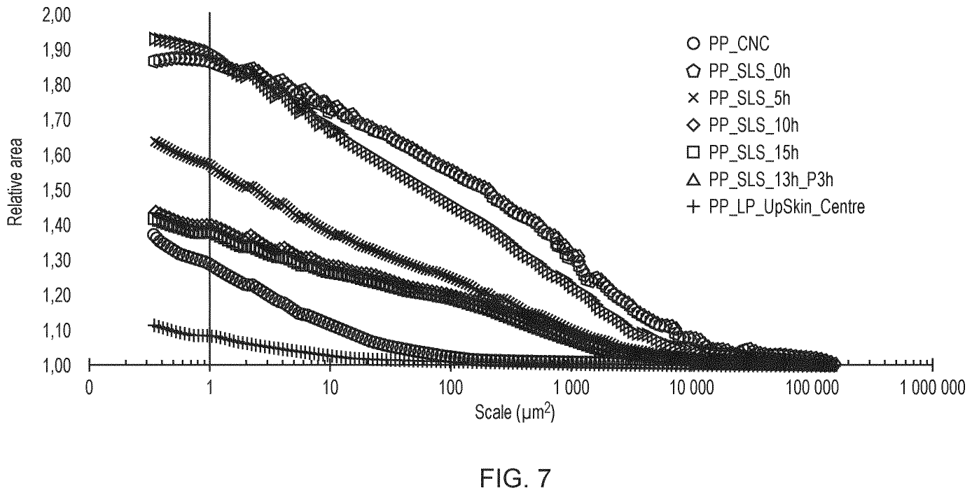

FIG. 7 shows a plot of relative area of the surfaces of the different samples, as a function of scale. In FIG. 7, PP_SLS_LP is the data series with the lowest value at a scale of 1 μm², PP_CNC is the data series with the second-lowest value at a scale of 1 μm², PP_SLS_13h_3P is the data series with the highest value at a scale of 1 μm², PP_SLS_0h is the data series with the second-highest value at a scale of 1 μm², and the tumbled SLS samples show progressively lower values at a scale of 1 μm² in line with the postprocessing time.

For PP_CNC, FIG. 7 shows that the relative area reaches 1.4 as a maximum at small scales (below 1 μm²), while no surface features are accounted for at scales above 60 μm². The relevant scales are therefore from 1 μm² to 60 μm². For PP_SLS_LP, surface features are not accounted for at scales above 20 μm², while at small scales, the relative area is the lowest of all samples (1.12). The trend for PP_SLS_LP is similar to that for PP_CNC.

FIG. 7 also shows that PP_SLS_0h has a high relative area (1.9) at small scales, and a comparatively high relative area at scales up to 30,000 μm², meaning that roughness was accounted for at all scales. The tumbling effect reduced the relative area, but roughness can still be observed at large scales (above 60 μm²). There is a negligible effect of tumbling after 10 h of postprocessing, as shown by the similarity of the trends for PP_SLS_10h and PP_SLS_15h. These tumbling times resulted in a maximum relative area of 1.45. The use of polishing media for 3 h did not influence the surface texture.

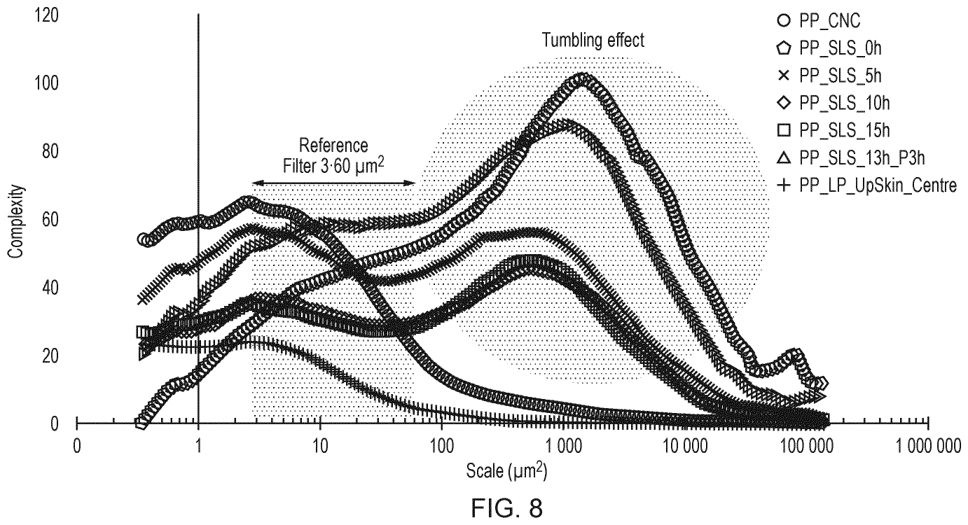

FIG. 8 shows a plot of complexity of the surfaces of the different samples, as a function of scale. In FIG. 8, the data series in ascending order of complexity at a scale of 1 μm² are: PP_SLS_0h, PP_SLS_LP, PP_SLS_10h, PP_SLS_15h (which is very similar in value to PP_SLS_10h), PP_SLS_13 h_3P, PP_SLS_5h and PP_CNC.

As shown in FIG. 8, PP_CNC exhibited a low complexity at medium and large scales, with a maximum complexity at 2 μm². For PP_SLS_0h, the highest complexity (100) was at high scales (around 2000 μm²). For the tumbled SLS samples, the complexity decreases as the postprocessing time increases up to 10 h. Polishing does not have an effect on complexity, as shown by the PP_SLS_13 h_3P having a similar trend to the as-printed samples. PP_SLS_LP had the lowest complexity at small scales, with complexity tending to unity from 100 μm².

From FIG. 8, the scale range used to filter the raw CLSM images and calculate areal roughness parameters can be obtained. PP_CNC (reference) samples are used to determine this scale range, which is from 3 μm² to 60 μm². Within this range, surface features that increase complexity are produced while machining. To calculate the filter lengths, the square roots of the end points of the area range (i.e. 3 μm² and 60 μm²) multiplied by two are taken, resulting in length range of 2.5 μm to 11 μm. This scale is used to apply a bandpass filter (i.e. between 2.5 μm and 11 μm) based on a robust Gaussian filter.

As explained above, PP_CNC and PP_SLS_LP samples were found to have the highest degree of cleanliness. Accordingly, PP_CNC and PP_SLS_LP samples were compared in order to identify the most relevant roughness parameters, by using the minimum degree of divergence of roughness parameters between the samples. This used Equation 1 below. The 72 surface roughness parameters set out in ISO 25178-2:2022 were considered.

$${DD}_{k} = \frac{\vert {\sum }_{i = 1}^{4} {μ}_{i , {PP}_{CNC}} ( k ) - {\sum }_{i = 1}^{4} {μ}_{i , {PP}_{SLS \_ LP}} ( k ) \vert}{{\sum }_{i = 1}^{4} {σ}_{i , {PP}_{CNC}} ( k ) + {\sum }_{i = 1}^{4} {σ}_{i , {PP}_{SLS LP}} ( k )} \qquad ( Equation 1 )$$

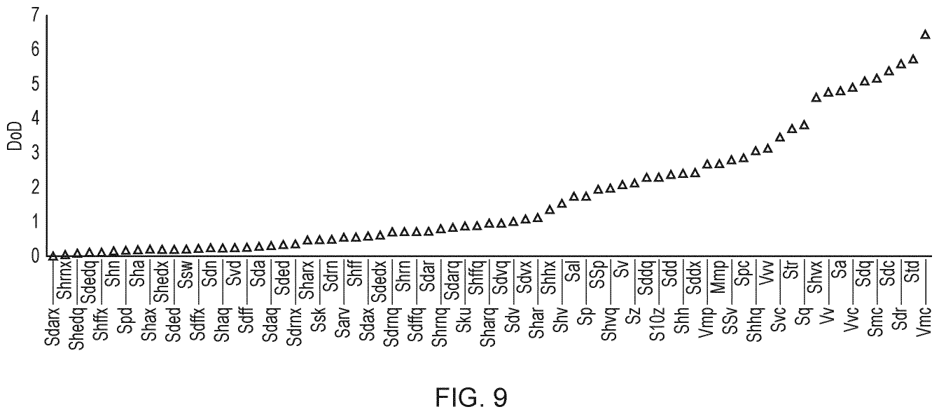

FIG. 9 shows the degree of divergence of the 72 evaluated surface roughness parameters. As shown in FIG. 9, Sdarx is the roughness parameter that best correlates to explain the similarities when PP_CNC and PP_SLS_LP samples are compared. This parameter was newly included in ISO 25178-2:2022 and defines the ratio of the maximum diameter to the minimum diameter (aspect ratio), as given by the equation Sdarx=max(Dₘₐₓ/Dₘᵢₙ). This parameter discriminates between compact and oblong motifs (for example, in the case of a disc, Sdarx=1, whereas for an oblong motif, Sdarx>1). Specifically, Sdarx is defined for the maximum aspect ratio of the dale regions.

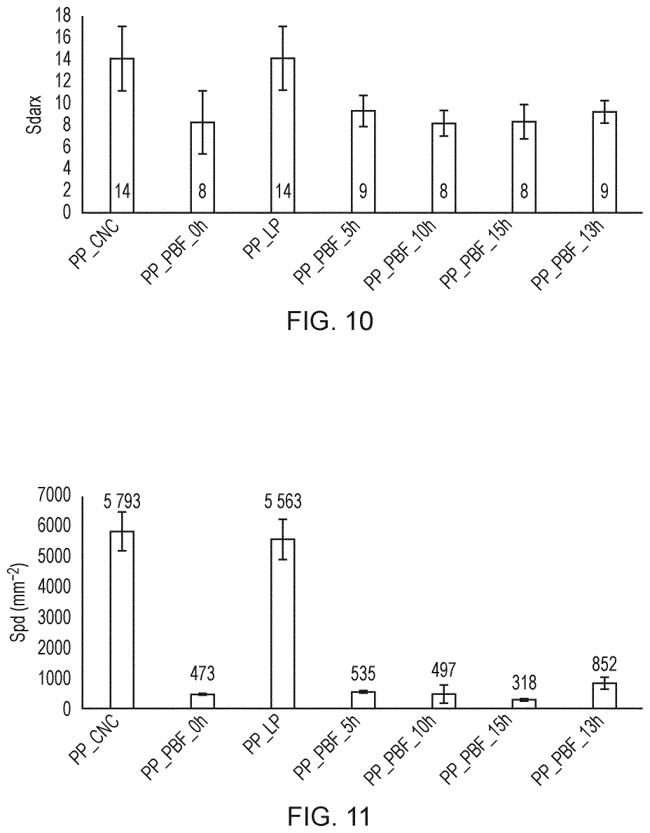

FIG. 10 shows the maximum dale aspect ratio of the reference (PP_CNC) and AM samples. As shown in FIG. 10, the same maximum aspect ratio is found for PP_CNC and PP_SLS_LP samples, while more rounded dales are obtained for SLS samples that were postprocessed by tumbling. Regardless of postprocessing time, Sdarx is approximately constant for each tumbled SLS sample.

FIG. 11 shows the density of peaks per area (Spd) of the reference (PP_CNC) and AM samples. Spd has a low (close to zero) degree of divergence value arising from the comparison of PP_CNC and PP_SLS_LP, as shown in FIG. 9, and correlates well to ATS removal. FIG. 11 shows that a larger density of peaks is present for PP_CNC and PP_SLS_LP samples (both within the range of 5000 to 6000 mm⁻²).

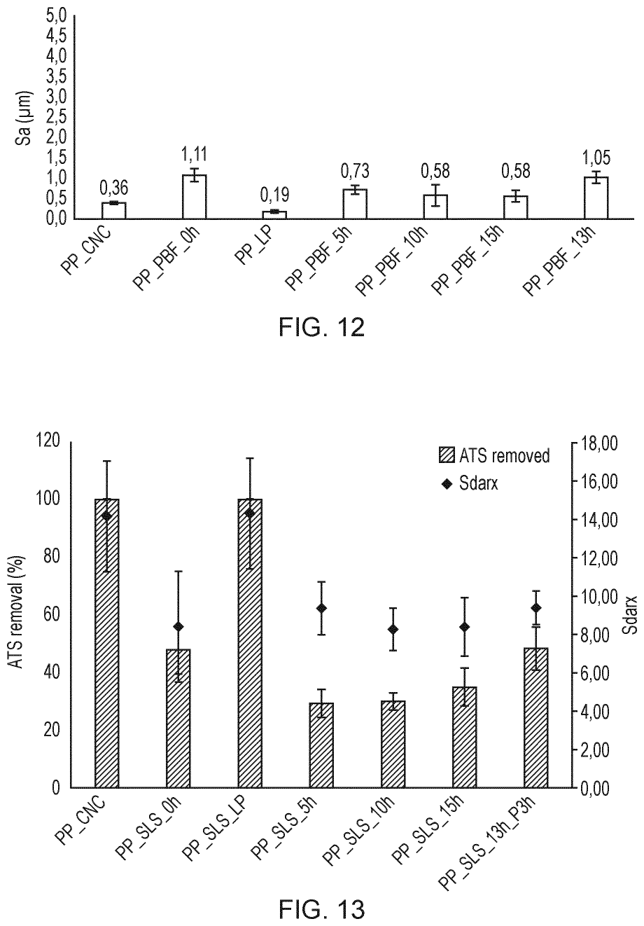

In order to demonstrate the need to use roughness parameters besides the average roughness, Sa, a plot of Sa is shown in FIG. 12. The similarities of the Sa values in FIG. 12 show the limitations of using this single parameter to describe surface features of components produced by CNC machining and AM technologies. In particular, Sa cannot describe the observed differences among different manufacturing processes.

FIG. 13 shows the correlation between ATS removal and Sdarx, while FIG. 14 shows the correlation between ATS removal and Spd. The autocorrelation length (Sal) has a low (under two) degree of divergence value arising from the comparison of PP_CNC and PP_SLS_LP, as shown in FIG. 9, and correlates well to ATS removal. The autocorrelation length defines the spatial longitude between each surface feature in a surface. FIG. 15 shows the correlation between ATS removal and Sal for each sample. It can be seen from FIG. 15 that reference (PP_CNC) samples have short distances between features, which may hinder the possibility for the ATS to attach and link to the surface, whereas AM surfaces are porous and have larger distances between surface features. As shown in FIGS. 13 to 15, the tumbling effect does not improve the efficiency of removing ATS from the surface, and in fact results in the opposite behaviour. That is, as-printed samples (PP_SLS_0h) with higher porosity and average roughness detached a higher percentage of ATS, when compared with SLS samples that were postprocessed by tumbling for 5 h, 10 h and 15 h. Conversely, SLS samples postprocessed by laser polishing show a similar effect to the CNC samples, as seen from FIGS. 13 to 15.

In the plot of Sdarx shown in FIG. 10, the Sdarx value of the PP_CNC sample is 14.16 and the Sdarx value of the PP_LP sample is 14.23. Postprocessing can be applied to a surface of a part manufactured by SLS in order to provide an Sdarx value that is in line with the Sdarx value of the PP_CNC and PP_LP samples. Specifically, postprocessing may be applied to the SLS surface to provide an Sdarx value of between 11 and 18, preferably between 12 and 17, more preferably between 13 and 16, and most preferably between 14 and 15.

In the plot of Spd shown in FIG. 11, the Spd value of the PP_CNC sample is 5793 mm⁻² and the Spd value of the PP_LP sample is 5563 mm⁻². Postprocessing can be applied to a surface of a part manufactured by SLS in order to provide an Spd value that is in line with the Spd value of the PP_CNC and PP_LP samples. Specifically, postprocessing may be applied to the SLS surface to provide an Spd value of between 3000 mm⁻² and 10000 mm⁻², preferably between 3500 mm⁻² and 9000 mm⁻², more preferably between 4000 mm⁻² and 8000 mm⁻², more preferably between 4500 mm⁻² and 7500 mm⁻², more preferably between 5000 mm⁻² and 7000 mm⁻², or most preferably between 5500 mm⁻² and 6500 mm⁻².

In the plot of Sal shown in FIG. 15, the Sal value of the PP_CNC sample is 2.97 μm and the Sal value of the PP_LP sample is 3.34 μm. Postprocessing can be applied to a surface of a part manufactured by SLS in order to provide an Sal value that is in line with the Sal value of the PP_CNC and PP_LP samples. Specifically, postprocessing may be applied to the SLS surface to provide an Sal value of less than 4.5 μm, preferably less than 4.25 μm, more preferably less than 4 μm, or most preferably less than 3.75 μm.

In the plot of Sku shown in FIG. 16, the Sku value of the PP_CNC sample is 13.73 and the Sku value of the PP_LP sample is 11.26. Postprocessing can be applied to a surface of a part manufactured by SLS in order to provide an Sku value that is in line with the Sku values of the PP_CNC and PP_LP samples. Specifically, postprocessing may be applied to the SLS surface to provide an Sku value of between 6 and 20, preferably between 7 and 18, more preferably between 8 and 16, or most preferably between 9 and 14.

In the plot of Svd shown in FIG. 17, the Svd value of the PP_CNC sample is 4944 mm⁻² and the Svd value of the PP_LP sample is 4570 mm⁻². Postprocessing can be applied to a surface of a part manufactured by SLS in order to provide an Svd value that is in line with the Svd values of the PP_CNC and PP_LP samples. Specifically, postprocessing may be applied to the SLS surface to provide an Svd value of between 3000 mm⁻² and 10000 mm⁻², preferably between 3500 mm⁻² and 8000 mm⁻², more preferably between 4000 mm⁻² and 7000 mm⁻², more preferably between 4500 mm⁻² and 6000 mm⁻², or most preferably between 4000 mm⁻² and 5000 mm⁻².

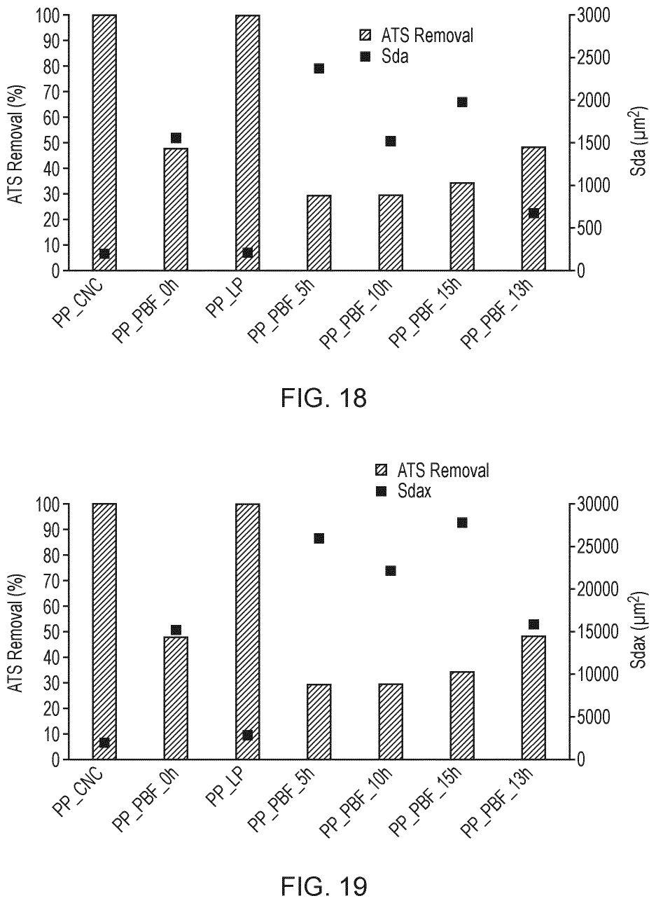

In the plot of Sda shown in FIG. 18, the Sda value of the PP_CNC sample is 208.4 μm² and the Sda value of the PP_LP sample is 229.6 μm². Postprocessing can be applied to a surface of a part manufactured by SLS in order to provide an Sda value that is in line with the Sda values of the PP_CNC and PP_LP samples. Specifically, postprocessing may be applied to the SLS surface to provide an Sda value of between 50 μm² and 600 μm², preferably between 75 μm² and 500 μm², more preferably between 100 μm² and 400 μm², more preferably between 125 μm² and 300 μm², or most preferably between 150 μm² and 250 μm².

In the plot of Sdax shown in FIG. 19, the Sdax value of the PP_CNC sample is 1977 μm² and the Sdax value of the PP_LP sample is 2862 μm². Postprocessing can be applied to a surface of a part manufactured by SLS in order to provide an Sdax value that is in line with the Sdax values of the PP_CNC and PP_LP samples. Specifically, postprocessing may be applied to the SLS surface to provide an Sdax value of less than 7000 μm², preferably less than 6000 μm², more preferably less than 5000 μm², more preferably less than 4000 μm², or most preferably less than 3000 μm².

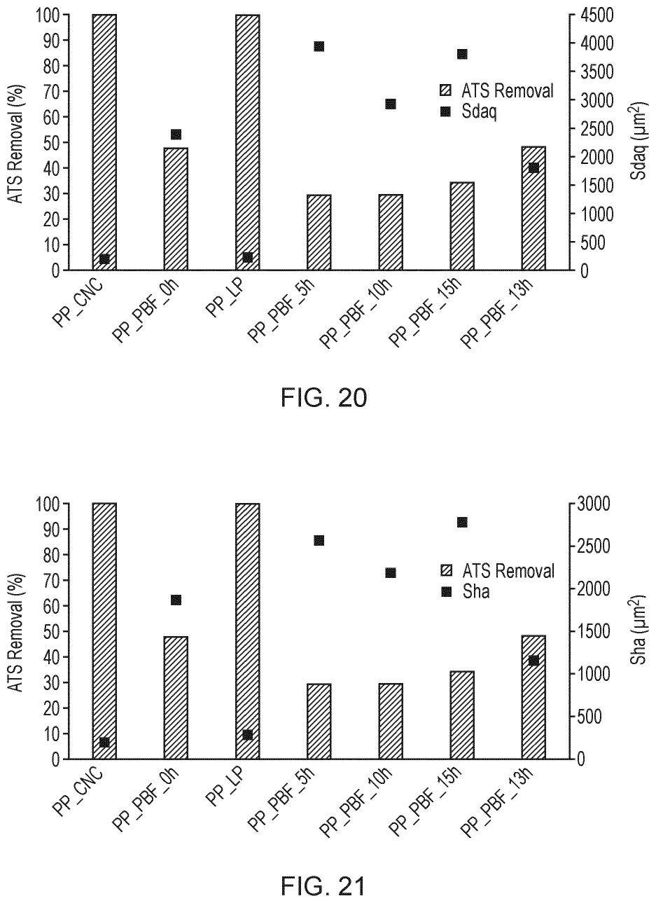

In the plot of Sdaq shown in FIG. 20, the Sdaq value of the PP_CNC sample is 196.1 μm² and the Sdaq value of the PP_LP sample is 226.0 μm². Postprocessing can be applied to a surface of a part manufactured by SLS in order to provide an Sdaq value that is in line with the Sdaq value of the PP_CNC and PP_LP samples. Specifically, postprocessing may be applied to the SLS surface to provide an Sdaq value of less than 600 μm², preferably less than 500 μm², more preferably less than 400 μm², more preferably less than 300 μm², and most preferably less than 250 μm².

In the plot of Sha shown in FIG. 21, the Sha value of the PP_CNC sample is 177.2 μm² and the Sha value of the PP_LP sample is 185.4 μm². Postprocessing can be applied to a surface of a part manufactured by SLS in order to provide an Sha value that is in line with the Sha values of the PP_CNC and PP_LP samples. Specifically, postprocessing may be applied to the SLS surface to provide an Sha value of between 50 μm² and 500 μm², preferably between 75 μm² and 400 μm², more preferably between 100 μm² and 300 μm², more preferably between 125 μm² and 250 μm², or most preferably between 150 μm² and 200 μm².

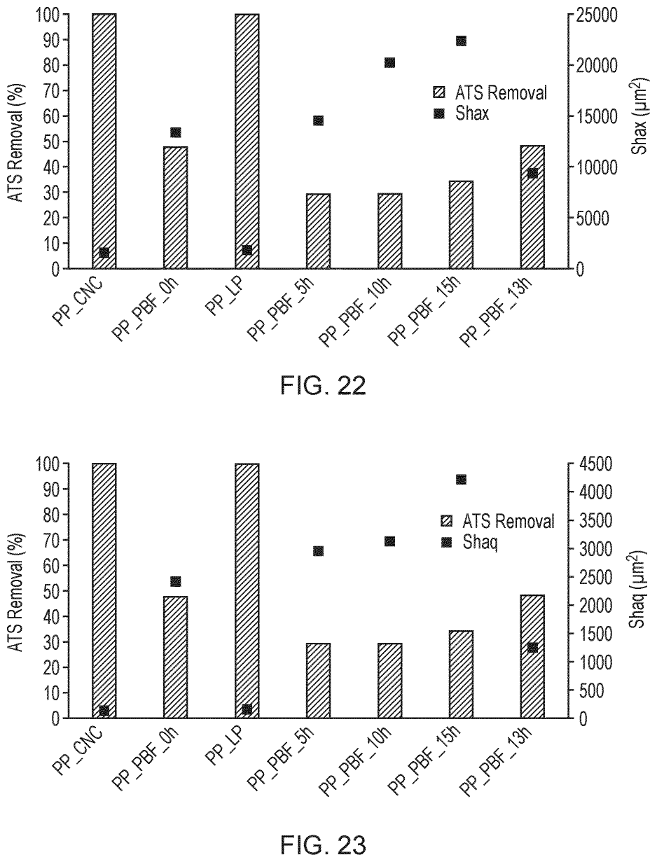

In the plot of Shax shown in FIG. 22, the Shax value of the PP_CNC sample is 1571 μm² and the Shax value of the PP_LP sample is 1771 μm². Postprocessing can be applied to a surface of a part manufactured by SLS in order to provide an Shax value that is in line with the Shax values of the PP_CNC and PP_LP samples. Specifically, postprocessing may be applied to the SLS surface to provide an Shax value of less than 6000 μm², preferably less than 5000 μm², more preferably less than 4000 μm², more preferably less than 3000 μm², or most preferably less than 2000 μm².

In the plot of Shaq shown in FIG. 23, the Shaq value of the PP_CNC sample is 145.5 μm² and the Shaq value of the PP_LP sample is 158.6 μm². Postprocessing can be applied to a surface of a part manufactured by SLS in order to provide an Shaq value that is in line with the Shaq values of the PP_CNC and PP_LP samples. Specifically, postprocessing may be applied to the SLS surface to provide an Shaq value of less than 500 μm², preferably less than 400 μm², more preferably less than 300 μm², more preferably less than 250 μm², and most preferably less than 200 μm².

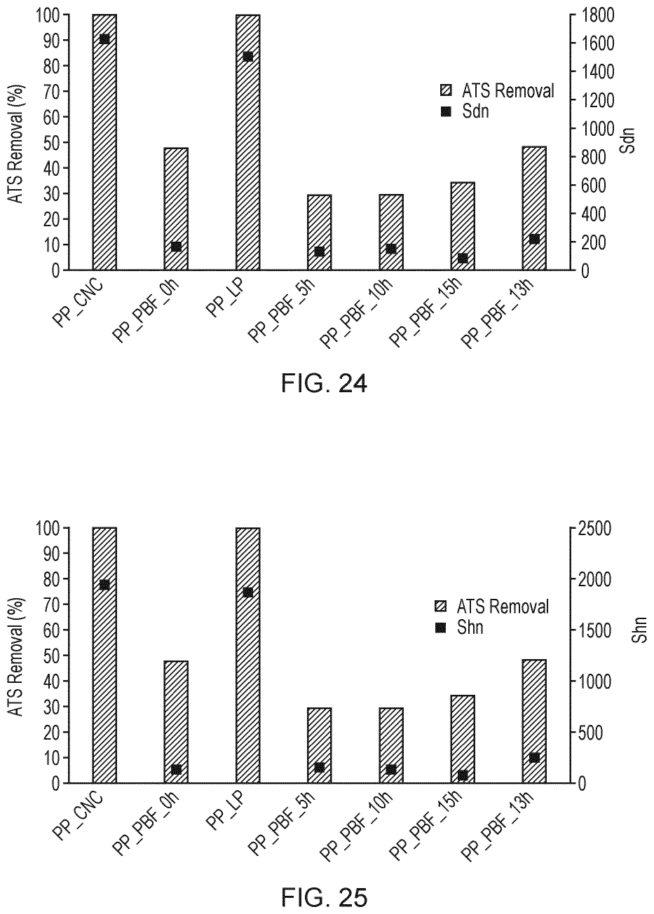

In the plot of Sdn shown in FIG. 24, the Sdn value of the PP_CNC sample is 1621 and the Sdn value of the PP_LP sample is 1496. Postprocessing can be applied to a surface of a part manufactured by SLS in order to provide an Sdn value that is in line with the Sdn values of the PP_CNC and PP_LP samples. Specifically, postprocessing may be applied to the SLS surface to provide an Sdn value of between 1000 and 2000, preferably between 1100 and 1900, more preferably between 1200 and 1800, more preferably between 1300 and 1700, and most preferably between 1400 and 1650.

In the plot of Shn shown in FIG. 25, the Shn value of the PP_CNC sample is 1925 and the Shn value of the PP_LP sample is 1850. Postprocessing can be applied to a surface of a part manufactured by SLS in order to provide an Shn value that is in line with the Shn values of the PP_CNC and PP_LP samples. Specifically, postprocessing may be applied to the SLS surface to provide an Sal value of between 1000 and 3000, preferably between 1200 and 2800, more preferably between 1400 and 2600, more preferably between 1600 and 2400, and most preferably between 1800 and 2200.

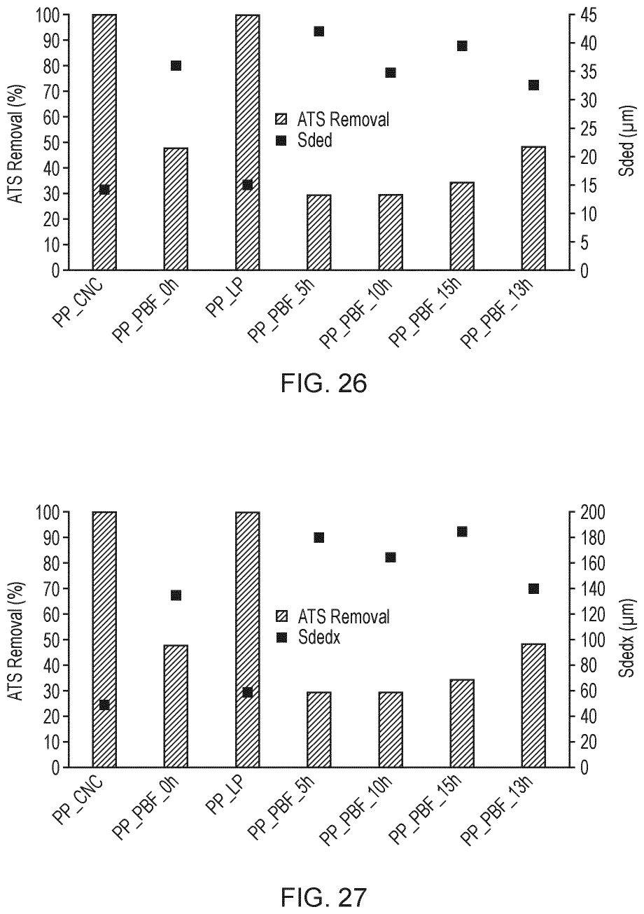

In the plot of Sded shown in FIG. 26, the Sded value of the PP_CNC sample is 14.10 μm and the Sded value of the PP_LP sample is 14.86 μm. Postprocessing can be applied to a surface of a part manufactured by SLS in order to provide an Sded value that is in line with the Sded values of the PP_CNC and PP_LP samples. Specifically, postprocessing may be applied to the SLS surface to provide an Sded value of between 6 μm and 24 μm, preferably between 8 μm and 22 μm, more preferably between 10 μm and 20 μm, more preferably between 12 μm and 18 μm, and most preferably between 14 μm and 16 μm.

In the plot of Sdedx shown in FIG. 27, the Sdedx value of the PP_CNC sample is 48.82 μm and the Sdedx value of the PP_LP sample is 58.13 μm. Postprocessing can be applied to a surface of a part manufactured by SLS in order to provide an Sdedx value that is in line with the Sdedx values of the PP_CNC and PP_LP samples. Specifically, postprocessing may be applied to the SLS surface to provide an Sdedx value of less than 90 μm, preferably less than 80 μm, more preferably less than 70 μm, more preferably less than 65 μm, and most preferably less than 60 μm.

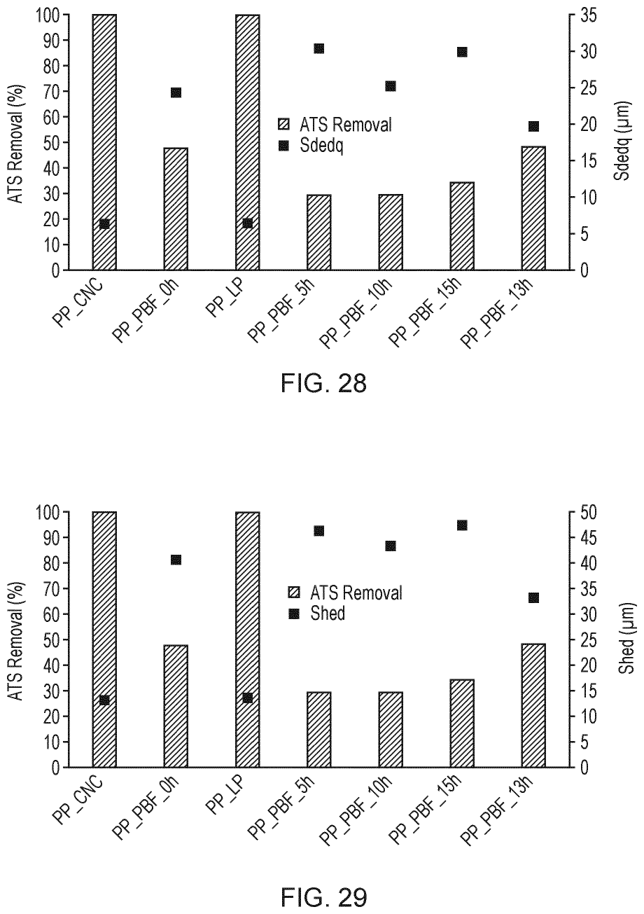

In the plot of Sdedq shown in FIG. 28, the Sdedq value of the PP_CNC sample is 6.30 μm and the Sdedq value of the PP_LP sample is 6.51 μm. Postprocessing can be applied to a surface of a part manufactured by SLS in order to provide an Sdedq value that is in line with the Sdedq values of the PP_CNC and PP_LP samples. Specifically, postprocessing may be applied to the SLS surface to provide an Sdedq value of less than 14 μm, preferably less than 11 μm, more preferably less than 9 μm, more preferably less than 8 μm, and most preferably less than 7 μm.

In the plot of Shed shown in FIG. 29, the Shed value of the PP_CNC sample is 13.15 μm and the Shed value of the PP_LP sample is 13.48 μm. Postprocessing can be applied to a surface of a part manufactured by SLS in order to provide an Shed value that is in line with the Shed value of the PP_CNC sample. Specifically, postprocessing may be applied to the SLS surface to provide an Shed value of between 5 μm and 23 μm, preferably between 7 μm and 21 μm, more preferably between 9 μm and 19 μm, more preferably between 11 μm and 17 μm, and most preferably between 13 μm and 15 μm.

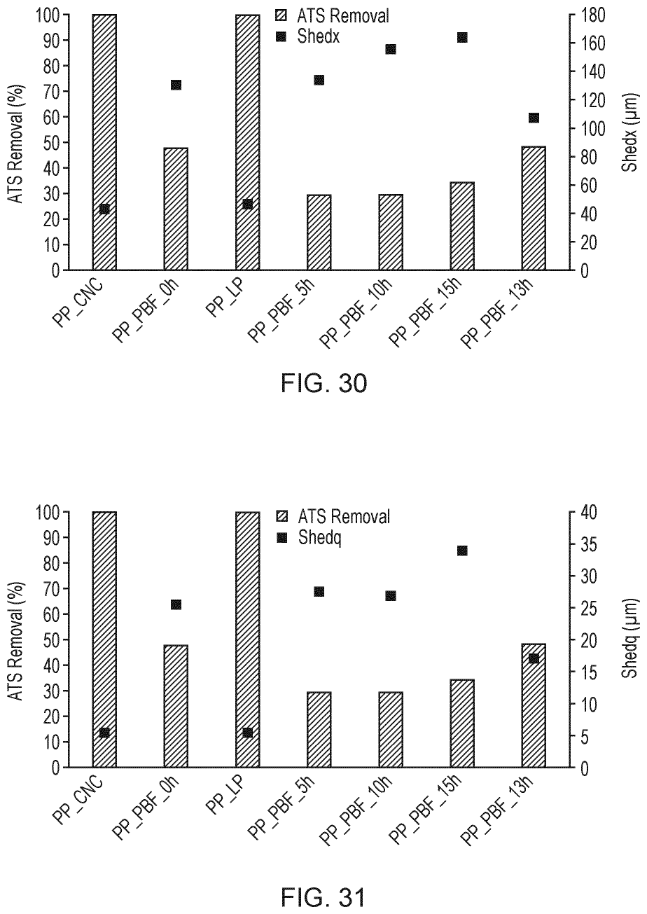

In the plot of Shedx shown in FIG. 30, the Shedx value of the PP_CNC sample is 43.21 μm and the Shedx value of the PP_LP sample is 45.91 μm. Postprocessing can be applied to a surface of a part manufactured by SLS in order to provide an Shedx value that is in line with the Shedx values of the PP_CNC and PP_LP samples. Specifically, postprocessing may be applied to the SLS surface to provide an Shedx value of less than 70 μm, preferably less than 65 μm, more preferably less than 60 μm, more preferably less than 55 μm, and most preferably less than 50 μm.

In the plot of Shedq shown in FIG. 31, the Shedq value of the PP_CNC sample is 5.32 μm and the Shedq value of the PP_LP sample is 5.43 μm. Postprocessing can be applied to a surface of a part manufactured by SLS in order to provide an Shedq value that is in line with the Shedq values of the PP_CNC and PP_LP samples. Specifically, postprocessing may be applied to the SLS surface to provide an Shedq value of less than 14 μm, preferably less than 11 μm, more preferably less than 9 μm, more preferably less than 8 μm, and most preferably less than 7 μm.

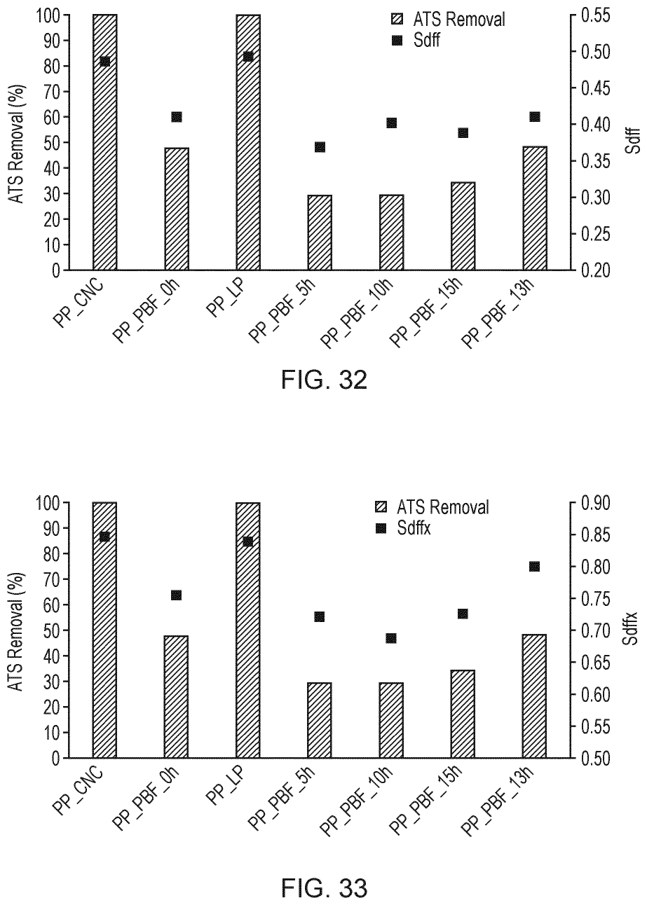

In the plot of Sdff shown in FIG. 32, the Sdff value of the PP_CNC sample is 0.486 and the Sdff value of the PP_LP sample is 0.491. Postprocessing can be applied to a surface of a part manufactured by SLS in order to provide an Sdff value that is in line with the Sdff values of the PP_CNC and PP_LP samples. Specifically, postprocessing may be applied to the SLS surface to provide an Sdff value of between 0.44 and 0.54, preferably between 0.45 and 0.53, more preferably between 0.46 and 0.52, more preferably between 0.47 and 0.51, or most preferably between 0.48 and 0.50.

In the plot of Sdffx shown in FIG. 33, the Sdffx value of the PP_CNC sample is 0.847 and the Sdffx value of the PP_LP sample is 0.839. Postprocessing can be applied to a surface of a part manufactured by SLS in order to provide an Sdffx value that is in line with the Sdffx values of the PP_CNC and PP_LP samples. Specifically, postprocessing may be applied to the SLS surface to provide an Sdffx value of between 0.815 and 0.875, preferably between 0.825 and 0.865, or more preferably between 0.835 and 0.855.

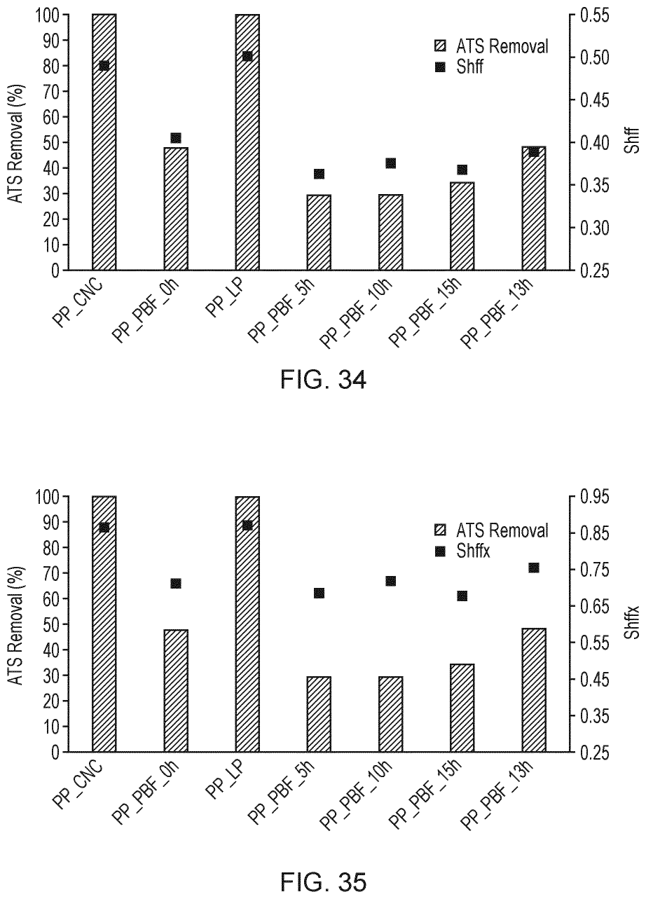

In the plot of Shff shown in FIG. 34, the Shff value of the PP_CNC sample is 0.492 and the Shff value of the PP_LP sample is 0.503. Postprocessing can be applied to a surface of a part manufactured by SLS in order to provide an Shff value that is in line with the Shff values of the PP_CNC and PP_LP samples. Specifically, postprocessing may be applied to the SLS surface to provide an Shff value of between 0.45 and 0.55, preferably between 0.46 and 0.54, more preferably between 0.47 and 0.53, more preferably between 0.48 and 0.52, or most preferably between 0.49 and 0.51.

In the plot of Shffx shown in FIG. 35, the Shffx value of the PP_CNC sample is 0.864 and the Shffx value of the PP_LP sample is 0.871. Postprocessing can be applied to a surface of a part manufactured by SLS in order to provide an Shffx value that is in line with the Shffx values of the PP_CNC and PP_LP samples. Specifically, postprocessing may be applied to the SLS surface to provide an Shffx value of between 0.80 and 0.94, preferably between 0.82 and 0.92, more preferably between 0.84 and 0.90, or most preferably between 0.86 and 0.88.

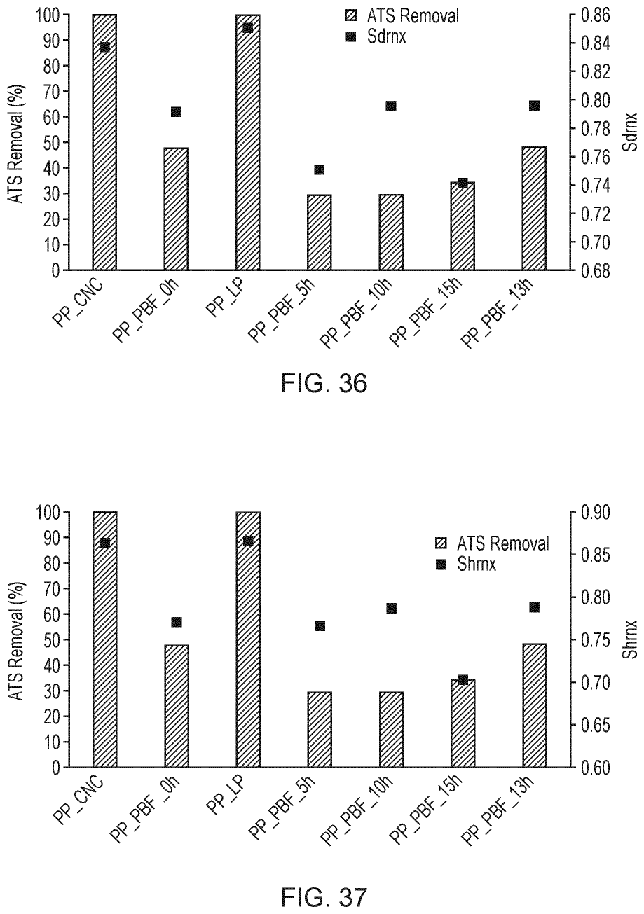

In the plot of Sdrnx shown in FIG. 36, the Sdrnx value of the PP_CNC sample is 0.837 and the Sdrnx value of the PP_LP sample is 0.850. Postprocessing can be applied to a surface of a part manufactured by SLS in order to provide an Sdrnx value that is in line with the Sdrnx values of the PP_CNC and PP_LP samples. Specifically, postprocessing may be applied to the SLS surface to provide an Sdrnx value between 0.815 and 0.875, preferably between 0.825 and 0.865, or more preferably between 0.835 and 0.855.

In the plot of Shrnx shown in FIG. 37, the Shrnx value of the PP_CNC sample is 0.862 and the Shrnx value of the PP_LP sample is 0.864. Postprocessing can be applied to a surface of a part manufactured by SLS in order to provide an Shrnx value that is in line with the Shrnx values of the PP_CNC and PP_LP samples. Specifically, postprocessing may be applied to the SLS surface to provide an Shrnx value of between 0.83 and 0.90, preferably between 0.84 and 0.89, more preferably between 0.85 and 0.88, or most preferably between 0.86 and 0.87.

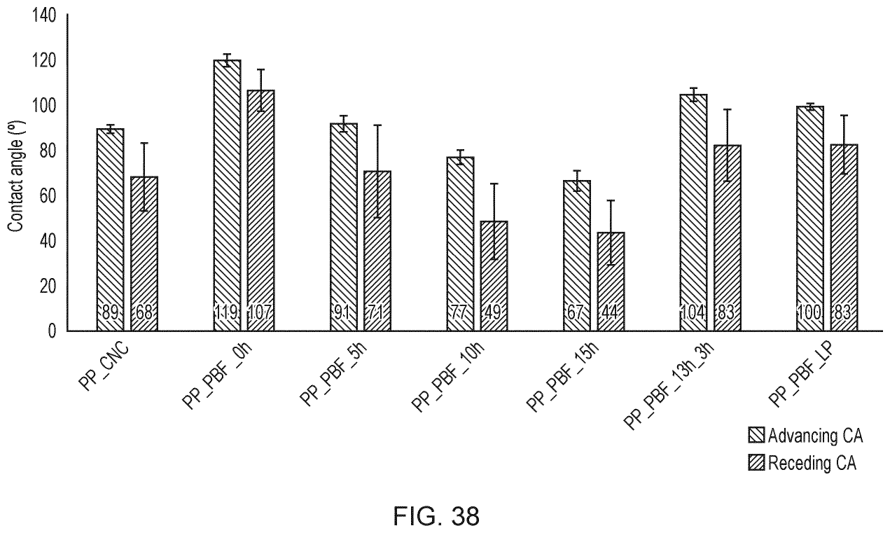

In the plot of advancing and receding contact angles (ACA and RCA) shown in FIG. 38, the ACA value of the PP_CNC sample is 89 degrees and the ACA value of the PP_LP sample is 100 degrees. Postprocessing can be applied to a surface of a part manufactured by SLS in order to provide an ACA value that is in line with the ACA values of the PP_CNC and PP_LP samples. Specifically, postprocessing may be applied to the SLS surface to provide an ACA value of between 80 degrees and 110 degrees, preferably between 82.5 degrees and 107.5 degrees, more preferably between 85 degrees and 105 degrees, or most preferably between 87.5 degrees and 102.5 degrees. The RCA value of the PP_CNC sample is 68 degrees and the RCA value of the PP_LP sample is 83 degrees. Postprocessing can be applied to a surface of a part manufactured by SLS in order to provide an ACA value that is in line with the ACA values of the PP_CNC and PP_LP samples. Specifically, postprocessing may be applied to the SLS surface to provide an ACA value of between 55 degrees and 95 degrees, preferably between 57.5 degrees and 92.5 degrees, more preferably between 60 degrees and 90 degrees, more preferably between 62.5 degrees and 87.5 degrees, or most preferably between 65 degrees and 85 degrees.

Variations or modifications to the systems and methods described herein are set out in the following paragraphs.

It will also be appreciated that the methods described herein are not limited to the evaluation of surfaces of parts produced by PBF, and may also be applied to surfaces of parts produced by other AM techniques. Moreover, it will be appreciated that the methods described herein are not, in fact, limited to the evaluation of surfaces of parts produced by an AM technique, and may alternatively or additionally be applied to surfaces of parts produced using other manufacturing techniques.

In addition, the methods described herein are not limited to the evaluation of flat surfaces. In particular, the method of FIG. 2 may be used to validate the cleanability of other features of manufactured parts, such as pockets, cavities and corners. This can be done by identifying relevant roughness parameters based on a comparison with corresponding features of parts produced using manufacturing methods that are currently used to produce cleanable features of parts used in bioprocessing applications (such as CNC milling).

The described methods may be implemented using computer executable instructions. A computer program product or computer readable medium may comprise or store the computer executable instructions. The computer program product or computer readable medium may comprise a hard disk drive, a flash memory, a read-only memory (ROM), a CD, a DVD, a cache, a random-access memory (RAM) and/or any other storage media in which information is stored for any duration (e.g., for extended time periods, permanently, brief instances, for temporarily buffering, and/or for caching of the information). A computer program may comprise the computer executable instructions. The computer readable medium may be a tangible or non-transitory computer readable medium. The term “computer readable” encompasses “machine readable”.

The singular terms “a” and “an” should not be taken to mean “one and only one”. Rather, they should be taken to mean “at least one” or “one or more” unless stated otherwise. The word “comprising” and its derivatives including “comprises” and “comprise” include each of the stated features, but does not exclude the inclusion of one or more further features.

The above implementations have been described by way of example only, and the described implementations are to be considered in all respects only as illustrative and not restrictive. It will be appreciated that variations of the described implementations may be made without departing from the scope of the invention. It will also be apparent that there are many variations that have not been described, but that fall within the scope of the appended claims.

1. A method (100) of producing a part for use in a bioprocessing system, the method comprising:
manufacturing (110) the part using an additive manufacturing process;
and postprocessing (120) a surface of the part,
wherein the surface is intended to be wetted in use; wherein the postprocessed surface has one or more of the following areal roughness parameter values measured in accordance with ISO 25178-2:2022,
wherein the one or more areal roughness parameter values are measured (220) for the surface after filtering the surface to remove surface features having wavelengths below 2.5 pm and surface features having wavelengths above 11 pm:
a mean dale area, Sda, of between 50 pm² and 600 pm²; a mean hill area, Sha, of between 50 pm² and 500 pm²; a density of peaks, Spd, of between 3000 mm′² and 10000 mm′²; and
a kurtosis, Sku, of between 6 and 20.

2. The method (100) according to claim 1, wherein the part is manufactured using powder bed fusion.

3. The method (100) according to claim 2, wherein the part is manufactured using selective layer sintering.

4. The method (100) according to claim 1, wherein postprocessing the surface comprises laser polishing of the surface.

5. The method (100) according to claim 1, wherein the mean dale area, Sda, of the postprocessed surface is between 75 pm² and 500 pm², preferably between 100 pm² and 400 pm², more preferably between 125 pm² and 300 pm², or most preferably between 150 pm² and 250 pm².

6. The method (100) according to claim 1, wherein the mean hill area, Sha, of the postprocessed surface is between 75 and 400 pm², preferably between 100 and 300 pm², more preferably between 125 and 250 pm², or most preferably between 150 and 200 pm².

7. The method (100) according to claim 1, wherein the density of peaks, Spd, of the postprocessed surface is between 3500 mm⁻² and 9000 mm⁻², preferably between 4000 mm⁻² and 8000 mm′²; more preferably between 4500 mm⁻² and 7500 mm−², more preferably between 5000 mm⁻² and 7000 mm⁻², or most preferably between 5500 mm⁻² and 6500 mm².

8. The method (100) according to claim 1, wherein the kurtosis, Sku, of the postprocessed surface is between 7 and 18, more preferably between 8 and 16, or most preferably between 9 and 14.

9. The method (100) according to claim 1, wherein the postprocessed surface has an autocorrelation length, Sal, measured in accordance with ISO 25178-2:2022, of between 2 pm and 4.5 pm, preferably between 2.25 pm and 4.25 pm, more preferably between 2.5 pm and 4 pm, or most preferably between 2.75 pm and 3.75 pm, wherein the autocorrelation length, Sal, is measured for the surface after filtering the surface to remove surface features having wavelengths below 2.5 pm and surface features having wavelengths above 11 pm.

10. The method (100) according to claim 1, wherein the postprocessed surface has a maximum dale area, Sdax, measured in accordance with ISO 25178-2:2022, of less than 7000 pm², preferably less than 6000 pm², more preferably less than 5000 pm², more preferably less than 4000 pm², or most preferably less than 3000 pm², wherein the maximum dale area, Sdax, is measured for the surface after filtering the surface to remove surface features having wavelengths below 2.5 pm and surface features having wavelengths above 11 pm.

11. The method (100) according to claim 1, wherein the postprocessed surface has a maximum hill area, Shax, measured in accordance with ISO 25178-2:2022, of less than 6000 pm², preferably less than 5000 pm², more preferably less than 4000 pm², more preferably less than 3000 pm², or most less than 2000 pm², wherein the maximum hill area, Shax, is measured for the surface after filtering the surface to remove surface features having wavelengths below 2.5 pm and surface features having wavelengths above 11 pm.

12. The method (100) according to claim 1, wherein the postprocessed surface has a density of pits, Svd, measured in accordance with ISO 25178-2:2022, of between 3000 mm² and 10000 mm², preferably between 3500 mm² and 8000 mm²′, more preferably between 4000 mm⁻² and 7000 mm⁻², more preferably between 4500 mm−² and 6000 mm⁻², or most preferably between 4000 mm⁻² and 5000 mm⁻², wherein the density of pits, Svd, is measured for the surface after filtering the surface to remove surface features having wavelengths below 2.5 pm and surface features having wavelengths above 11 pm.

13. The method (100) according to claim 1, wherein the postprocessed surface has a mean hill form factor, Shff, measured in accordance with ISO 25178-2:2022, of between 0.45 and 0.55, preferably between 0.46 and 0.54, more preferably between 0.47 and 0.53, more preferably between 0.48 and 0.52, or most preferably between 0.49 and 0.51, wherein the mean hill form factor, Shff, is measured for the surface after filtering the surface to remove surface features having wavelengths below 2.5 pm and surface features having wavelengths above 11 pm.

14. The method (100) according to claim 1, wherein the postprocessed surface has a mean dale form factor, Sdff, measured in accordance with ISO 25178-2:2022, of between 0.44 and 0.54, preferably between 0.45 and 0.53, more preferably between 0.46 and 0.52, more preferably between 0.47 and 0.51, or most preferably between 0.48 and 0.50, wherein the mean dale form factor, Sdff, is measured for the surface after filtering the surface to remove surface features having wavelengths below 2.5 pm and surface features having wavelengths above 11 pm.

15. The method (100) according to claim 1, wherein an advancing contact angle of the postprocessed surface is between 80 degrees and 110 degrees, preferably between 82.5 degrees and 107.5 degrees, more preferably between 85 degrees and 105 degrees, or most preferably between 87.5 degrees and 102.5 degrees.

16. The method (100) according to claim 1, wherein a receding contact angle of the postprocessed surface is between 55 degrees and 95 degrees, preferably between 57.5 degrees and 92.5 degrees, more preferably between 60 degrees and 90 degrees, more preferably between 62.5 degrees and 87.5 degrees, or most preferably between 65 degrees and 85 degrees.

17. An additively manufactured part for use in a bioprocessing system, wherein the additively manufactured part comprises a surface intended to be wetted in use, wherein the surface has one or more of the following areal roughness parameter values measured in accordance with ISO 25178-2:2022, wherein the one or more areal roughness parameter values are measured for the surface after filtering the surface to remove surface features having wavelengths below 2.5 pm and surface features having wavelengths above 11 pm: a mean dale area, Sda, of between 50 and 600 pm²; a mean hill area, Sha, of between 50 and 500 pm²; a density of peaks, Spd, of between 3000 mm⁻² and 10000 mm⁻²; and a kurtosis, Sku, of between 6 and 20.

18. The additively manufactured part according to claim 17, wherein the mean dale area, Sda, of the postprocessed surface is between 75 and 500 pm², preferably between 100 and 400 pm², more preferably between 125 and 300 pm², or most preferably between 150 and 250 pm².

19. The additively manufactured part according to claim 17, wherein the mean hill area, Sha, of the postprocessed surface is between 75 and 400 pm², preferably between 100 and 300 pm², more preferably between 125 and 250 pm², or most preferably between 150 and 200 pm².

20. The additively manufactured part according to claim 17, wherein the density of peaks, Spd, of the postprocessed surface is between 3500 mm⁻² and 9000 mm′², preferably between 4000 mm⁻² and 8000 mm′²; more preferably between 4500 mm² and 7500 mm′², more preferably between 5000 mm′² and 7000 mm′², or most preferably between 5500 mm′² and 6500 mm′².

21. The additively manufactured part according to claim 17, wherein the kurtosis, Sku, of the postprocessed surface is between 7 and 18, more preferably between 8 and 16, or most preferably between 9 and 14.

22. A method (230) of determining cleanability of a surface of a part for use in a bioprocessing system, the method comprising:
manufacturing (210) the part,
wherein the part comprises a surface that is intended to be wetted in use; and one or more of: measuring a mean dale area, Sda, of the surface after filtering the surface to remove surface features having wavelengths below 2.5 pm and surface features having wavelengths above 11 pm, and
determining that the surface is cleanable if the mean dale area, Sda, of the surface is between 50 pm² and 600 pm²; measuring a mean hill area, Sha, of the surface after filtering the surface to remove surface features having wavelengths below 2.5 pm and surface features having wavelengths above 11 pm, and
determining that the surface is cleanable if the mean dale area, Sda, of the surface is between 50 pm² and 500 pm²;
measuring a density of peaks, Spd, of the surface after filtering the surface to remove surface features having wavelengths below 2.5 pm and surface features having wavelengths above 11 pm, and
determining that the surface is cleanable if the density of peaks, Spd, of the surface is between 3000 mm′² and 10000 mm′²; and measuring a kurtosis, Sku, of the surface after filtering the surface to remove surface features having wavelengths below 2.5 pm and surface features having wavelengths above 11 pm, and determining that the surface is cleanable if the kurtosis, Sku, of the surface is between 6 and 20.
